(19) United States
(12) Patent Application Publication
(10) Pub. No.: US 2020/0144797 A1
(43) Pub. Date: May 7, 2020

(54) SYSTEM FOR INSTALLING CABLES IN PARALLEL

(71) Applicant: PCS DEVELOPING CO. B.V., Castricum (NL)

(72) Inventor: Theodoor Johannes Gerardus BRUIJNSE, Castricum (NL)

(73) Assignee: PCS DEVELOPING CO. B.V., Castricum (NL)

(21) Appl. No.: 16/607,748

(22) PCT Filed: May 1, 2018
(86) PCT No.: PCT/EP2018/061075

§ 371 Date: Oct. 24, 2019

(30) Foreign Application Priority Data
May 1, 2017 (NL) 2018822

(51) Int. Cl. H02G 1/08; F16L 3/223; F16L 3/237; H02G 11/02

(52) U.S. Cl. CPC H02G 1/081; H02G 11/02; F16L 3/237; F16L 3/2235

(57) ABSTRACT

A system for installing cables includes at least one cable reel filled with at least two cables wound in parallel and in several windings upon the cable reel as a set of cables. The system includes at least one pre-installed cable binder, where the parallel wound cables are mutually joined along at least part of the length of the cables by means of the at least one preinstalled cable binder.

### TECHNICAL FIELD

The present invention relates to a system for installing cables, in particular single core power cables. The present invention furthermore relates to a method for installing power cables using such a system, as well as to a cable binder for use in such a system.

Although the invention is hereinafter described with reference to single core power cables, the invention is also applicable to other cables, as well as to systems and methods wherein one or more cables (being either single core power cables or other cables) are enclosed in a single flexible tubular cable enclosure. The cable enclosures may be installed first using the system or the method, and the cable or cables may be inserted into the cable enclosures thereafter to form enclosed cables.

### PRIOR ART

Single core power cables are used in electricity networks to interconnect electrical components. For instance, in electricity distribution networks, single core power cables are used to interconnect successive electrical substations. Within such an electrical (distribution) substation, typically comprising one or more transformers and one or more switchgear buildings, single core power cables are for instance used to connect a transformer to a switchgear building.

In case of a faulty switchgear building in an electrical distribution substation, the result is a power outage for the residential buildings, the industrial buildings etc. that are provided with electricity via the affected substation.

In order to restore distribution of electricity to the residential buildings, industrial buildings etc. it is known to provide one or more mobile emergency switchgear containers for temporarily replacing the faulty switchgear building while the latter is being repaired. For restoring distribution of electricity via the mobile emergency switchgear container(s), an electrical connection is set up that bypasses the faulty switchgear building via the mobile emergency switchgear container(s). For setting up the electrical bypass, temporary single core power cables need to be installed for connecting the transformer(s) to the mobile emergency switchgear container(s) and possibly (if no three core cables are used) for connecting the mobile emergency switchgear container(s) to the outbound power cables of the electrical distribution substation. Installing the temporary single core power cables includes arranging these cables, typically a multiple of three, that are delivered to the substation wound on individual cable reels together with the mobile emergency switchgear container(s), along a path between the transformer(s) and the mobile emergency switchgear container(s) and along a path between the mobile emergency switchgear container(s) and a location suitable for connecting the temporary single core power cables to the outbound cables of the substation. Subsequently, the ends of the temporary single core power cables are connected to the transformer(s) and the mobile emergency switchgear container(s) respectively the mobile emergency switchgear container(s) and the outbound cables of the electrical distribution substation. Finally, after connecting the temporary single core power cables, the distribution of electricity to the residential buildings, he industrial buildings etc. affected by the power outage can be restored.

Installing the temporary single core power cables for setting up the bypass is time consuming, whereas the time for restoring the distribution of electricity should be as short as possible in order to limit the effects of the power outage.

### SUMMARY OF THE INVENTION

The present invention has as one of its objectives to make installing cables, in particular single core power cables less time consuming.

Thereto the present invention provides a system for installing cables, the system comprising at least one cable reel filled with at least two cables wound in parallel and in several windings upon the cable reel as a set of cables. When using the system according to the invention, the cable reel filled with at least two single core power cables wound in parallel and in several windings upon the cable reel as a set of single core power cables, allows for arranging multiple single core power cables at once as a set of single core power cables along a path by moving the cable reel along the path while unwinding or by pulling the at least two single core power cables from the cable reel as a set of single core power cables. This significantly reduces the time for installing multiple single core power cables relative to arranging the multiple single core power cables along the path one at the time.

Preferably, the at least two single core power cables wound on the cable reel as a set of single core power cables are at at least one end thereof, more preferably both ends thereof, prepared for electrical connection. This reduces time for connecting the set of single core power cables to electrical components that need to be electrically connected by means of the set of power cables. Preferably, respective ends of the power cables are prepared for electrical connection by being provided with an electrical connector or termination. Alternatively or additionally respective ends of the power cables are prepared to be electrically connected to another power cable by means of, for instance, a connection joint.

In an advantageous embodiment of the system according to the invention, the system comprises at least one cable binder configured for mutually joining at least two of the power cables in parallel relationship. At least after arranging the single core power cables along a path between electrical components to be connected, the at least one cable binder allows for positioning the parallel power cables the one relative to the other, and for keeping the relative position of the power cables the one relative to the other. Preferably, the at least one cable binder is configured to hold the power cables mutually separated by a predefined distance. Single core power cables arranged in parallel influence each other during use. For instance in three-phase electricity networks the current rating and the inductance of parallel single core power cables are influenced by amongst others the mutual distance between them. Being able to hold the power cables mutually separated by a predefined distance by means of the cable binder, advantageously provides control over the influence of the parallel power cables on each other. In a preferred embodiment of the system according to the present invention, the at least one cable binder is configured to hold the power cables mutually separated by a predefined distance that equals to substantially one time the outer diameter of the cables. The current rating of parallel single core power cables increases with increasing mutual distance between them, whereas the inductance of parallel single core power cables decreases with decreasing mutual distance between them and vice versa. By holding the parallel single core power cables mutually separated by a predefined distance that equals to substantially one time the outer diameter of the cables, an advantageous balance between the current rating and the inductance of the parallel single core power cables is achieved. However, in case the system is used for other types of cables, wherein the mutual forces between the cables are much less or non-existent, the distance between the cables may advantageously be as small as possible in order to provide a compact system.

Furthermore, in order to withstand the EM-forces that may be caused by the short circuit currents in the cable system, the cable binder may preferably be made of a fiber reinforced plastic material which is provided with strong fibers, such as Dyneema™, which fibers preferably extend substantially parallel to the direction perpendicular to, and through the cores of, the at least two cables. Preferably the fibers have a length which is larger than the distance between the outer two cables.

Furthermore, the at least one cable binder is preferably designed for mutually joining the power cables in a short-circuit proof way. Due to the electromechanical forces in case of a three-phase short-circuit parallel single core power cables can be explosively displaced away from each other in transverse direction.

By making the at least one cable binder for mutually joining the power cables short-circuit proof, i.e. designing the at least one cable binder to withstand the electromechanical forces in case of a three-phase short-circuit, the explosive displacement of the parallel power cables away from each other in transverse direction due to the electromechanical forces in case of a three-phase short-circuit can be prevented, thereby increasing the safety of three-phase electricity networks with multiple single core power cables in parallel.

Preferably, the at least one cable binder is configured to hold the power cables in a row that extends transverse to the longitudinal direction of the cables, more preferably the at least one cable binder is configured to hold the power cables in a single plane.

In a preferred embodiment of the system according to the invention the at least one cable binder comprises at least one preinstalled cable binder; and the parallel wound power cables are mutually joined along at least part of the length of the power cables by means of the at least one preinstalled cable binder. By having at least one cable binder being preinstalled on the set of single core power cables wound in parallel and in several windings upon the cable reel along at least part of the length of the power cables, arranging a set of mutually joined multiple single core power cables at once along a path is advantageously possible by moving the cable reel along the path while unwinding or by pulling the mutually joined multiple single core power cables from the cable reel. This significantly reduces the time for arranging multiple single core power cables along a path in parallel relationship wherein the multiple single core power cables are mutually joined along at least part of the length of the cables. In particular a significant reduction of installation time is achieved relative to a typical embodiment of the know method for installing single core power cables as discussed herein above wherein multiple single core power cables are arranged along a path one at the time, and wherein the positions of the single core power cables the one relative to the other are set and held e.g. by digging trenches in a ground surface and arranging the power cable in respective trenches. Preferably each preinstalled cable binder binds together all power cables of the set of power cable wound upon the cable reel. Alternatively, each preinstalled cable binder binds together a subset of the set of power cable wound upon the cable reel, wherein preferably different subsets of the set of power cable are bound together according to an alternating pattern. It would also be possible that some preinstalled cable binders bind together all power cables of the set of power cable wound upon the cable reel, while other preinstalled cable binders bind together different subsets of the set of power cable.

In a preferred embodiment of the system according to the invention that includes at least one preinstalled cable binder, the system comprises a plurality of preinstalled cable binders; and neighbouring preinstalled cable binders are mutually offset in longitudinal direction of the power cables. Preferably, the preinstalled cable binders are distributed along part of the length of the power cables such that preinstalled cable binders of adjacent windings do not overlap. In a further preferred embodiment the offset distance along the length of the power cables between neighbouring preinstalled cable binders is such that along the offset distance, the stiffness of the power cables is suitable for maintaining the cables mutually separated by a predefined distance. It is noted that the greater the offset distance between neighbouring preinstalled cable binders, the sturdier the preinstalled cable binders will need to be in order to be short-circuit proof, i.e. in order to be able to withstand the forces associated with a short-circuit. Typically, the sturdier the preinstalled cable binder, the larger its dimensions (for a given material quality). The larger the dimensions of the preinstalled cable binder, the larger is the height of each winding and the fewer windings will fit on a cable reel. In view of the latter, when striving to fit as many as possible windings upon the cable reel, one would rather choose smaller offset distances between neighbouring preinstalled cable binders along the length of the power cables than larger offset distances.

In a further advantageous embodiment of the system according to the invention comprising at least one preinstalled cable binder, the preinstalled cable binder is configured for mutually joining at least two of the cables in parallel relationship, wherein the preinstalled cable binder comprises a first cable coupling that is configured to couple the preinstalled cable binder to one of the power cables such that translation of this power cable relative to the preinstalled cable binder in longitudinal direction of the power cable is blocked. The first coupling advantageously ensures that the preinstalled cable binder is kept on its chosen location along the length of the power cables. Preferably, the preinstalled cable binder further comprises at least one second cable coupling, that is configured to couple the preinstalled cable binder to the at least one other power cable, such that translation of the at least one other power cable relative to the preinstalled cable binder in longitudinal direction of the power cable is allowed. This allows for the power cables to translate the one relative to the other in longitudinal direction of the power cables while still being mutually joined, in order to compensate for differences in length of the respective paths of the power cables in case the path along which the power cables are arranged has one or more curves with different bending radii between the cables within the same curve.

In a further advantageous embodiment of the system according to the invention comprising at least one preinstalled cable binder, the first cable coupling is further configured to couple the cable binder to said power cable such that rotation of the cable relative to the cable binder about the central longitudinal axis of the power cable is allowed. This allows for preinstalled cable binders that are coupled to the same power cable by means of first couplings at different locations along the length of the power cables to have different angular orientation about the central longitudinal axis of said power cable. This advantageously prevents the power cable that is coupled by means of first couplings of preinstalled cable binders at different locations along the length of the power cables, to be subjected to torsion.

In a preferred embodiment of the system according to the invention comprising at least one preinstalled cable binder and a first cable coupling that allows for rotation, the first cable coupling comprises a clamping bush that is configured to be clamped on the cable and that allows for the cable to fully or partially rotate in the cable binder body of the preinstalled cable binder about the central longitudinal axis of the clamping bush. Preferably, the first cable coupling comprises a clamping bush accommodation in a cable binder body of the preinstalled cable binder for accommodating the clamping bush therein, wherein the clamping bush and the clamping bush accommodation have mating cylindrical surfaces that allow for the clamping bush to rotate in the clamping bush accommodation about the central longitudinal axis of the clamping bush, and wherein at least one of the clamping bush and the cable binder body has an at least partly circumferential groove in which at least a part of the other one of the clamping bush and the cable binder body extends.

In a further advantageous embodiment of the system according to the invention as described herein above having a first coupling that blocks translation of one of the cables relative to the preinstalled cable binder and a second coupling that allows translation of the at least one other of the cables relative to the preinstalled cable binder, the at least one second coupling comprises a preferably cylindrical cable accommodation for accommodating a cable therein, wherein the preferably cylindrical cable accommodation is preferably venturi tube-shaped. This allows the power cable whilst translating relative to the preinstalled cable binder along the length of the power cables to tilt relative to the cable accommodation to some degree without being blocked. Additionally a low friction ring could be arranged in the throat of the venturi tube-shaped cable accommodation in order to facilitate translation of the power cable relative to the preinstalled cable binder along the length of the power cables.

In a further advantageous embodiment of the system according to the invention as described herein above having a first coupling that blocks translation of one of the cables relative to the preinstalled cable binder, the preinstalled cable binder is configured to mutually join an uneven number of cables in parallel, the preinstalled cable binder is configured to hold the cables in a row extending transverse to the longitudinal direction of the cables and the middle cable of the uneven number of cables in parallel is coupled to the preinstalled cable binder by means of the first cable coupling.

In a preferred embodiment of the system according to the invention, each cable of the set of single core power cables is at both ends thereof provided with an electrical connector, which electrical connectors are mating. This feature allows for connecting two corresponding sets of single core power cables in a series connection. Alternatively the connectors are non-mating, which would require the use of additional connection joints for connecting two corresponding sets of single core power cables in a series connection.

In an advantageous embodiment of the system according to the invention, the system comprises a set of single core extension power cables, and at least one set of single core connector power cables configured for electrically connecting the set of extension power cables to an electrical installation. In an advantageous embodiment thereof, each of the connector power cables is at one end thereof prepared for electrical connection to the electrical installation and is at another end thereof provided with one of two mating electrical connectors, and each of the extension power cables is at one end thereof provided with the other one of the two mating electrical connectors. Alternatively, the electrical connectors of the connector cables and the electrical connectors of the extension cables are non-mating electrical connectors and the system comprises extra connection joints for connecting the electrical connectors of the connector cables to the electrical connectors of the extension cables.

In an advantageous embodiment of the system according to the invention having single core extension power cables and single core connector power cables, the at least one cable reel comprises a cable reel wherein the set of single core power cables wound upon the cable reel is the set of single core extension power cables. Alternatively or additionally, the at least one cable reel comprises a cable reel wherein the set of single core power cables wound upon the cable reel is the set of single core connector power cables.

In a further advantageous embodiment of the system according to the invention as described herein above having at least one cable binder, the at least one cable binder comprises at least one uninstalled cable binder configured for mutually joining unjoined parts of the set of cables.

In a further advantageous embodiment of the system according to the invention as described herein above having at least one cable binder, the at least one cable binder comprises a fixed number cable binder designed for mutually joining in parallel a fixed number of cables.

In a preferred embodiment thereof the fixed number cable binder comprises a set of two mating cable binder bodies, wherein at least one of the mating cable binder bodies comprises respective cable accommodations for the fixed number of cables, which cable accommodations are configured to receive, in an unmated state of the mating cable binder bodies, the cables transverse to the longitudinal direction of the cables; and wherein in a mated state of the mating cable binder bodies the cables received in the cable accommodations of one of the two mating cable binder bodies are locked in the cable accommodations by means of the other one of the two mating cable binder bodies. Preferably, the mating cable binder bodies are interlocking. Furthermore, the mating cable binder bodies are preferably identical.

In an advantageous embodiment of the system according to the invention described herein above comprising a fixed number cable binder having a set of two mating cable binder bodies, the fixed number cable binder is configured to hold the cables with the central axes of the cables extending in a single plane and the fixed number cable binder comprises two end walls arranged on at least one of the mating cable binder bodies that extend beyond said plane in the mated state of the cable binder bodies.

In a further advantageous embodiment of the system according to the invention described herein above comprising a fixed number cable binder having a set of two mating cable binder bodies, the mating cable binder bodies are connected by means of a hinge such that the mating cable binder bodies are rotatable the one relative to the other between the mated and the unmated state. In a preferred embodiment thereof the cable binder bodies are provided with a quick-fastener for fastening the cable binder bodies the one to the other in the mated state of the mating cable binder bodies. Alternatively, instead of the hinge, a second quick fastener may be used to fasten the cable binder bodies the one to the other.

In an advantageous alternative embodiment of the system according to the invention described herein above comprising a fixed number cable binder, the fixed number cable binder comprises a single cable binder body that is provided with respective accommodations for the fixed number of cables, which accommodations are configured to receive the cables transverse to the longitudinal direction of the cables, and comprises a locking member configured for locking the power cables in the accommodations, wherein preferably the locking member is a strip or a strap.

In a preferred embodiment thereof wherein the locking member is a strip, the mating cable binder body and the strip are connected by means of a hinge such that the cable binder body and the strip are rotatable the one relative to the other between an unlocked and a locked state, and the strip and the mating cable binder body are preferably provided with a quick-fastener for fastening the cable binder body and the strip the one to the other in the locked state. Alternatively, instead of the hinge, a second quick fastener may be used to fasten the locking strip to the cable binder body in the locked state of the cable binder body and the locking strip.

As an alternative for or in addition to fixed number cable binders, the at least one cable binder of advantageous embodiments of the system according to the present invention comprises a modular cable binder that comprises cable binder modules that are configured to accommodate at least one cable. Such a modular cable binder advantageously allows for providing cable binders for binding together any number of cables by providing as many cable binder modules as required and assembling these cable binder modules to provide the modular cable binder. In a preferred embodiment each cable binder module comprises a set of two mating cable binder bodies, wherein at least one of the mating cable binder bodies comprises a cable accommodation for one power cable, which cable accommodation is configured to receive the power cable transverse to the longitudinal direction of the power cables in an unmated state of the mating cable binder bodies and wherein in a mated state of the mating cable binder bodies the power cable received in the accommodation of one of the two mating cable binder bodies is locked in the accommodation by means of the other one of the two mating cable binder bodies. Preferably, the two mating cable binder bodies are identical. In an advantageous embodiment, the two mating cable binder bodies are interlocking, wherein preferably the mating cable binder bodies each comprise side walls that mate in parallel relationship in the mated state of the mating cable binder bodies and delimit in the mated state of the mating cable binder bodies opposite sides of the accommodation. Alternatively, the cable binder bodies each comprise on opposite sides of the accommodation one of a protrusion and a recess that mate in the mated state of the cable binder bodies. Providing interlocking mating cable binder bodies facilitates aligning the mating cable binder bodies. Furthermore, providing interlocking mating cable binder bodies contributes to the resistance of the cable binder against forces that force the cable binder bodies apart in a locking direction of the interlocking mating cable binder bodies.

In an advantageous embodiment of the system according to the invention having at least one modular cable binder comprising cable binder modules that each comprises a set of two mating cable binder bodies, the cable binder modules are configured to be arranged in a row. In said row the sets of two mating cable binder bodies may be arranged in parallel, i.e. with each first one of each set of two mating cable binder bodies in a first row and each second one of each set of two mating cable binder bodies in a second row parallel to the first row. Alternatively, the sets mating cable binder bodies of the cable binder modules may be arranged in series, i.e. with all cable binder bodies of the sets of cable binder bodies of the cable binder modules in a single row.

In an advantageous embodiment of the system according to the invention described herein having at least one modular cable binder comprising cable binder modules that are arranged in a row, each of the cable binder modules has at least one through hole, the through holes of the cable binder modules are aligned when the cable binder modules are arranged in a row, and the cable binder comprises a fastener configured to extend through the aligned through holes and to hold the cable binder modules together. In a preferred embodiment each of the cable binder modules has at least two through holes, preferably arranged on opposite sides of the cable accommodation, wherein the fastener is U-shaped and the legs of the U-shape are configured to be arranged through the through holes. One or more fasteners extending through aligned through holes of the cable binder bodies provide an effective means for tying the cable binder modules together. In an alternative embodiment the modular cable binder comprises a strap, and the cable binder modules are configured to be strapped together by means of this strap.

The set of power cables wound upon the at least one cable reel of the system according to the present invention, may be arranged along a path between electrical components and/or installations to be electrically connected by pulling the set of power cables of the cable reel and along the path.

For facilitating the pulling of the set of power cables of the cable reel and along the path, advantageous embodiments of the system according to the present invention comprise a cable pulling device configured to be attached to one end of the set of parallel wound cables. Preferably, the cable pulling device comprises a cable attachment configured to be attached to one of the at least two power cables at an end of the power cable, the cable attachment preferably comprising a cable stocking. In addition to the cable attachment, the cable pulling device comprises a respective cable engagement for the at least one other power cable and configured to be arranged on the power cable that is attached to the cable attachment, the cable engagement being configured to engage the end of the at least one other power cable, the end of the other power cable preferably having a connector or termination arranged thereon, while allowing back and forth translation of the end of the power cable engaged by the cable engagement relative to and along a part of the length of the power cable that is attached to the cable attachment. In this preferred cable pulling device, the one or more engaged power cables of the set of power cables are allowed to translate relative to the attached power cable over a certain distance in order to compensate for differences in length of the respective paths of the engaged power cables relative to the attached power cable in case the path along which the power cables are arranged has curves. In a preferred embodiment the cable engagement comprises a, preferably flexible, tube or sleeve that is configured to receive therein the end of the power cable engaged by the cable engagement. Preferably, the guide tube or sleeve has arranged therein a spring, preferably a coil spring, that is configured to engage the end of the power cable received in the guide tube or sleeve in a coaxial relationship with the power cable. In an advantageous embodiment of the system according to the present invention wherein the spring is a coil spring, the coil spring has arranged balls on the coils thereof, and preferably spacers are arranged on the coils between the balls. The balls arranged on the coils are substantially of the same size and may substantially fill the space between the end of the power cable and the inner surface of the tube or sleeve along which the end of the power cable is allowed to translate. By substantially filling the space between the end of the power cable and the inner surface of the tube or sleeve, tilting of the end of the power cable, preferably having a connector or termination arranged thereon, in the tube or sleeve may be reduced. Preferably the balls have a hole through which the respective coils extend. The optional spacers between the balls may be smaller balls or coil springs arranged on the coils between the balls.

In an advantageous embodiment of the system according to the present invention comprising a pulling device including cable engagements comprising a tube or sleeve having a spring arranged therein, the pulling device comprises a first spring engagement member that is configured to be fixed to the cable having attached thereto the cable attachment and to be engaged by one side of the spring. Preferably, the spring engagement member is a preinstalled cable binder as defined in embodiments of the system according to the invention described herein above. Optionally a second spring engagement member is configured to be fixed between the connector or termination at the end of the engaged power cable and the other side of the spring.

For facilitating the pulling of the set of power cables of the cable reel and along the path, advantageous embodiments of the system according to the present invention further comprise a corner cable guide arrangement that is configured to be anchored at a location along a path along which the set of power cables is to be pulled and provided with a cable guide configured for guiding the set of power cables around a corner when pulling the set of power cables along the path. Preferably, the cable guide comprises a bend guide tube or a banked cable tray. The bend guide tube and the banked cable tray are particularly advantageous in the embodiments of the system according to the present invention comprising preinstalled cable binders. The bend guide tube and the banked cable tray allow for the preinstalled cable binders to tilt in the corners, thereby contributing to compensation for differences in length of the respective paths of the power cables in the corner.

The single core power cables of the system according to the present invention are in particular medium or low voltage single core power cables.

In an advantageous embodiment of the system according to the present invention, the at least one cable reel is arranged on a spindle that is arranged on a vehicle frame, preferably of a self-propelled vehicle, or the cable reel is arranged on a spindle that is arranged on a stationary frame. Being arranged on a spindle that is arranged on a vehicle frame, preferably of a self-propelled vehicle, allows for pulling the set of cables along a path, as well as for moving the cable reel along a path while unwinding the set of cables. Being arranged on a spindle that is arranged on a stationary frame allows for pulling the set of cables along a path. In a preferred embodiment the vehicle frame or stationary frame is provided with a drive for rotating the cable reel about an axis of rotation defined by the spindle. Such drive allows for rewinding the set of cables upon the cable reel after use. One cable reel may be arranged on the spindle for installing one set of at least two cables. Alternatively, the system may comprise multiple cable reels each filled with at least two cables, wherein the cable reels are arranged on one spindle. This allows for arranging multiple sets of cables along a path at once. Alternatively, for arranging multiple sets of cables along a path at once, one multi-compartment cable reel each compartment filled with at least two cables may be arranged on the spindle for installing multiple sets of single core power cables. This allows for arranging multiple sets of cables along a path at once.

In an advantageous embodiment of the system according to the present invention the system is arranged in a container, preferably an intermodal container.

As described herein above, embodiments of the system according to the present invention are advantageously used for installing power cables for bypassing a substation of an electricity network in whole or in part during an outage. Alternatively, embodiments of the system according to the present invention are advantageously used for installing power cables for electrically connecting components on a temporary or semi-permanent basis. For instance the set of power cables may advantageously be used in a shore power connection for a ship that is temporarily moored in a harbour. The set of power cables may also advantageously be used on temporary or semi-permanent power generation sites, e.g. for electrically connecting the site electrical components and/or installations to other electric components and/or installations or to an electricity network. For instance the set of power cables may be used for electrically connecting mobile generator sets to electrical installations.

The present invention further relates to a method of installing cables, comprising: providing an embodiment of the system according to the invention as described herein above, arranging the cables that are wound in parallel and in several windings upon a cable reel as a set of power cables along a path between two electrical components or installations. In an advantageous embodiment the arranging of the cables along the path is by unwinding the cable reel while the cable reel is moved along the path. Alternatively, the arranging of the cables along the path is by unwinding the cable reel by pulling the cables as a set along the path.

The present invention further relates to a cable binder for use in a system according to the present invention, which cable binder is described herein above in the description of embodiments of the system according to the present invention. In particular the present invention relates to the cable binder described herein above as preinstalled cable binder.

The invention in particular also relates to a cable binder, wherein the cable binder comprises a cable binder body that is provided with respective accommodations for a fixed number of cables, which accommodations are configured to receive the cables transverse to the longitudinal direction of the cables, and comprises a locking member configured for locking the cables in the accommodations, wherein preferably the locking member is a strap. In order to prevent the cable binder from sliding downwards when hanging free in the air, preferably screw-eyes are provided between the cable accommodations to hook up the cable binder. Preferably the cable binder body comprises an elongated main body part, wherein at least two divider walls extend from one side of said main body part, substantially perpendicular thereto, at a distance from the outer ends of said main body part, wherein at least one of said cable accommodations is formed by an adjacent pair of said at least two divider walls and the part of the main body part extending between said pair of divider walls, and wherein two of said cable accommodations are each formed by one of said at least two divider walls and the adjacent outer end of said main body part. Preferably the main body part is provided with oblique or curved wall parts adjacent said divider walls, such that the cables are fixed in a predetermined position when the locking member is locking the cables in the accommodations. Preferably the locking member is a strap which is wound around the main body part and the divider walls while the cable present in the cable accommodations. Preferably the top side of the main body part of the cable binder body is provided with strap guiding means, for preventing lateral movement of the strap, which may be in the form of upright side ridges. Strap holders (for instance in the form of bars, for instance formed by bolts) may be provided inside said cable accommodations formed by each adjacent pair of said at least two divider walls and the part of the main body part extending between said pair of divider walls, which strap holders are arranged to hold said strap inside said cable accommodation on either side of the cable, thereby firmly engaging said cable and pulling the cable against the main body part. Said strap holders my be for instance in the form of bars, for instance formed by bolts, extending in parallel inside said cable accommodation, one on each side of the cable, wherein the strap is guided in a zig-zag manner inside the cable accommodation, first through the space between said strap holder and the main body part on one side of the cable, then around the cable and then through the space between said strap holder and the main body part on the other side of the cable. Preferably the cable binder body comprises three accommodations for holding three cables. Preferably the strap is closed and locked by means of a fast closing buckle. Preferably the cable binder body is made of a plastic material. Further preferred features of the cable binder are described in the following detailed description of the figures, in particular with reference to FIGS. 33-40.

### BRIEF DESCRIPTION OF THE FIGURES

The accompanying drawings are used to illustrate non-limitative preferred exemplary embodiments of the present invention. The above stated and other advantages, features and objectives of the invention will become more apparent, and the invention better understood, from the following detailed description when read in combination with the accompanying drawings, wherein:

FIGS. 1 to 6 show in schematic side view subsequent steps in a prior art method for installing single core power cables for bypassing a faulty switchgear building of an electrical (distribution) substation of an electricity network during an outage;

FIGS. 7 to 11 show in schematic side view subsequent steps in an embodiment of the method for installing single core power cables according to the invention that is FIGS. 7 to 11 is carried out for bypassing a faulty switchgear building of an electrical (distribution) substation of an electricity network during an outage, and show an embodiment of the system according to the invention that is used in the schematically shown method for installing a set of single core power cables;

FIG. 12 shows in schematic side view the arrangement of single core power cables in embodiments of a cable binder of the system according to the invention shown in FIGS. 7 to 11;

FIG. 13A shows in perspective view with parts taken away, an embodiment of a fixed number cable binder that is preinstalled on the set of single core power cables of the system according to the present invention as shown in FIGS. 7 to 11 as a preinstalled cable binder;

FIG. 13B shows in perspective, exploded view the cable binder of FIG. 13A;

FIG. 14 shows in top view a part of the length of the set of single core power cables of the system according to the present invention shown in FIGS. 7 to 11, said part of length having preinstalled thereon three preinstalled cable binders as per FIGS. 13A and 13B;

FIG. 15 shows in top view the part of the length of the set of single core power cables of FIG. 14 after being bend;

FIG. 16 shows in schematic side view a transformer of the substation shown in FIGS. 7 to 11 having arranged thereon single core connector power cables of the system according to the invention as shown in FIGS. 7 to 11;

FIG. 17A shows in schematic side view an embodiment of a fixed number cable binder of the system according to the present invention as shown in FIGS. 7 to 11, that is used on free hanging single core power cables e.g. as shown in FIG. 16 for arranging the single core connector power cables of the system according to the present invention as shown in FIGS. 7 to 11 on the transformer;

FIG. 17B shows in schematic side view an embodiment of a fixed number cable binder of the system according to the present invention as shown in FIGS. 7 to 11, that is used on free hanging or laying single core power cables e.g. as shown in FIG. 16 for arranging the single core connector power cables of the system according to the present invention as shown in FIGS. 7 to 11 on the transformer or on the ground;

FIG. 18 shows in perspective, exploded view an embodiment of a cable binder module of a modular cable binder for use in a system according to the present invention;

FIG. 19 shows in perspective view an embodiment of a modular cable binder for use in a system according to the present invention comprising three cable binder modules as shown in FIG. 18 that are used on free hanging single core power cables at fixed or variable mutual distances;

FIG. 20 shows in perspective, exploded view an alternative embodiment of a cable binder module of a modular cable binder for use in a system according to the present invention;

FIG. 21 shows in perspective view an alternative embodiment of a modular cable binder that is preinstalled on a set of single core power cables in a system according to the present invention as shown in FIGS. 7 to 11 as a preinstalled cable binder comprising three cable binder modules as shown in FIG. 20 or for use in a system according to the present invention comprising three cable binder modules as shown in FIG. 20 that is used on free hanging or laying single core power cables at fixed or variable mutual distances as a cable binder;

FIG. 22 shows in perspective view an alternative embodiment of a fixed number cable binder for use in a system according to the present invention as shown in FIGS. 7 to 11, that is used on free laying single core power cables e.g. as shown in FIG. 16 for arranging the single core connector power cables of the system according to the present invention as shown in FIGS. 7 to 11 on the ground;

FIG. 23 shows in perspective, exploded view the fixed number cable binder as shown in FIG. 22;

FIG. 24 shows in perspective view an alternative embodiment of a fixed number cable binder of the system according to the present invention as shown in FIGS. 7 to 11, that may be used on free hanging or laying single core power cables e.g. as shown in FIG. 16 for arranging the single core connector power cables of the system according to the present invention as shown in FIGS. 7 to 11 on the transformer or on the ground;

FIG. 25 shows in schematic top view a cable pulling device for the system according to the present invention as shown in FIGS. 7 to 11;

FIG. 26 shows in perspective view a spring for use in the cable pulling device of FIG. 25 as an alternative for a collar shown in FIG. 25 for prevent tilting of the two outer electrical connectors in the cable pulling device;

FIG. 27 shows in schematic top view the set of single core power cables of the system according to the present invention as shown in FIGS. 7 to 11 that is pulled along a path and is guided along curves in the path by means of a series of bend guide tubes;

FIG. 28 shows a cross sectional view of the set of single core power cables of FIG. 27 showing the orientation of the set of single core power cables in one of the bend guide tubes

FIG. 29 shows in perspective view a cable reel of a system according to the invention filled with a set of power cables;

FIG. 30 shows a side view of the cable reel of FIG. 29;

FIG. 31 shows a vehicle of a system according to the invention having arranged thereon four cable reels each filled with a set of power cables;

FIG. 32 shows a stationary frame of a system according to the invention having arranged thereon four cable reels each filled with a set of power cables;

FIG. 33 shows in perspective view an alternative embodiment of a fixed number cable binder of the system according to the present invention as shown in FIG. 24;

FIGS. 33-37 show respective front, side, top, and bottom views of the fixed number cable binder of FIG. 33;

FIG. 38 shows in a perspective view an alternative embodiment of a fixed number cable binder of the system according to the present invention as shown in FIG. 33; and

FIGS. 39 and 40 show in cross sectional view the fixed number cable binder of the system according to the present invention as shown in FIG. 33 in combination with power cables and a strap.

### DETAILED DESCRIPTION OF THE FIGURES

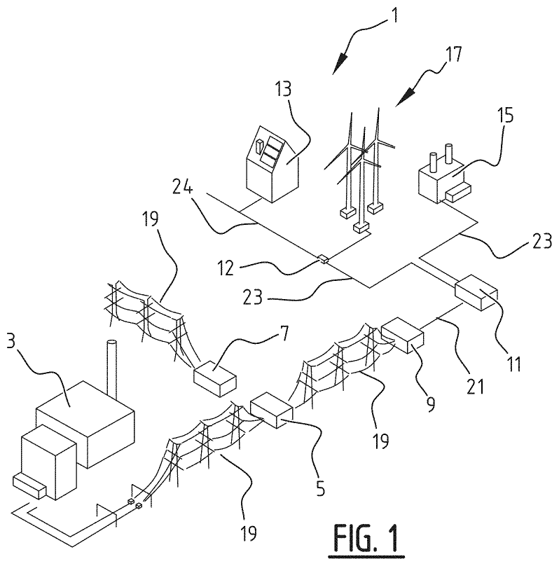

FIGS. 1 to 6 are illustrative of a prior art method for installing single core power cables for bypassing a substation or faulty components of a substation of an electricity distribution network during an outage.

In FIG. 1 a typical electricity (distribution) network 1 is shown, including a power generation plant 3, substations 5, 7, 9, 11, 12 a residential building 13, an industrial building 15, and a wind turbine park 17. The electricity network 1 further comprises high voltage power lines 19, intermediate voltage cables 21, medium voltage cables 23 and low voltage cables 24. The substations 9, 11, 12 include transformers that reduce the transmission or distribution voltage. For instance substation 9 includes transformers reducing the transmission voltage from high voltage, such as 150 kV, to intermediate voltage, such as 50 kV, whereas substation 12 includes transformers reducing the distribution voltage from medium voltage, such as 10 kV, to low voltage, such as 400 V.

In FIG. 2 substation 11 is schematically shown including a transformer 25, and a switchgear building 27.-The transformer 25 is connected to intermediate voltage cables 21. The transformer 25 is furthermore connected to the switchgear building 27 via medium voltage cables 29. In FIG. 2, substation 11 is in operational state such that, as illustrated in FIG. 2, residential buildings 13 and industrial buildings 15 connected to the respective substations 11 and 12 are provided with electricity.

In FIG. 3 is shown a situation wherein switchgear building 27 is faulty, resulting in an outage during which the residential buildings 13 and industrial buildings 15 connected to the respective substations 11 and 12 are no longer provided with electricity.

As shown in FIG. 4, for restoring the distribution of electricity to the residential buildings 13 and industrial buildings 15 one or more mobile emergency switchgear container(s) 31 is provided for temporarily replacing the faulty switchgear building 27 while the faulty switchgear building 27 is being repaired. For electrically connecting the mobile emergency switchgear container 31 to the transformer 25, cable reels 33, 35, 37 are delivered on site, each filled with a single core medium voltage power cable 39, 41, 43.

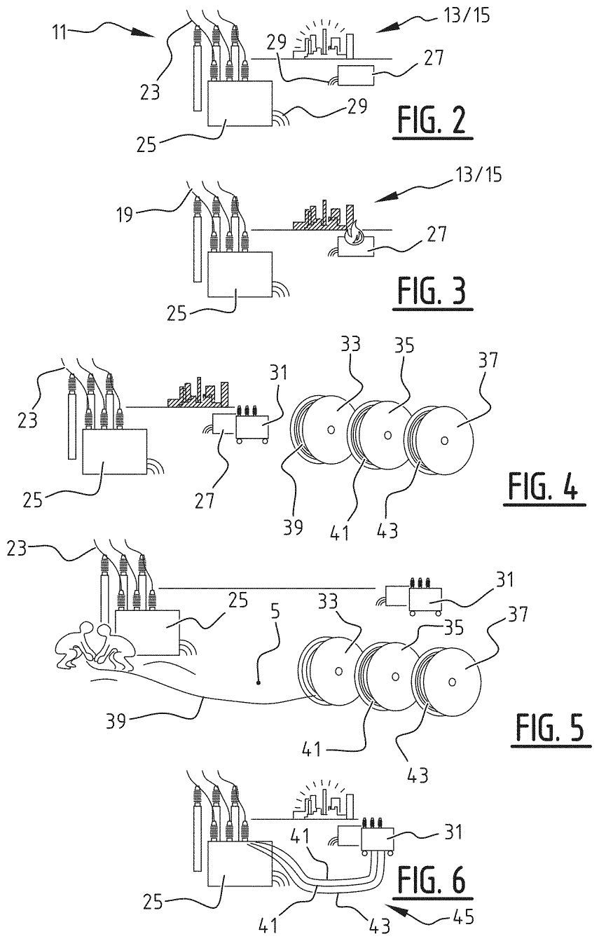

As illustrated in FIG. 5, each single core power cable 39, 41, 43 is unwound from the respective cable reel 33, 35, 37, and arranged along a path over the ground surface 45 between the transformer 25 and the mobile emergency switchgear container 31. Furthermore, the ends of the single core power cables 39, 41, 43 are prepared on site for connecting the one ends of the single core power cables 39, 41, 43 to terminals of the transformer 25 and for connecting the other ends of the medium voltage power cables 39, 41, 43 to the mobile emergency switchgear container 31. The preparing includes dismantling and stripping the ends of the single core power cables 39, 41, 43, and installing a termination or a connector on the ends of the single core power cables 39, 41, 43, that is compatible with the terminals of the transformer 25 and the mobile emergency switchgear container 31, respectively. Still further, before connecting the single core power cables 39, 41, 43 to the terminals of the transformer 25 and the mobile emergency switchgear container 31, the neighbouring parallel running single core power cables 39, 41, 43, need to be secured in place along the length of the single core power cables 39, 41, 43, wherein single core power cables 39, 41, 43 are secured in place with a certain minimum distance between neighbouring single core power cables 39, 41, 43. The single core power cables 39, 41, 43 need to be secured in place in order to prevent that the single core power cables 39, 41, 43 are explosively displaced the one away from the other in transverse direction due to the electromechanical forces in case of a three-phase short-circuit. Typically the single core power cables 39, 41, 43 are secured in place with a certain distance between neighbouring single core power cables 39, 41, 43, e.g. by digging trenches in the ground surface 45 and arranging the single core power cables 39, 41, 43 therein. After securing the single core power cables 39, 41, 43 in place along the length thereof, the single core power cables 39, 41, 43 can be connected to the terminals of the transformer 25 and the mobile emergency switchgear container 31, and the distribution of electricity to the residential buildings 13 and industrial buildings 15 can be restored as illustrated in FIG. 6.

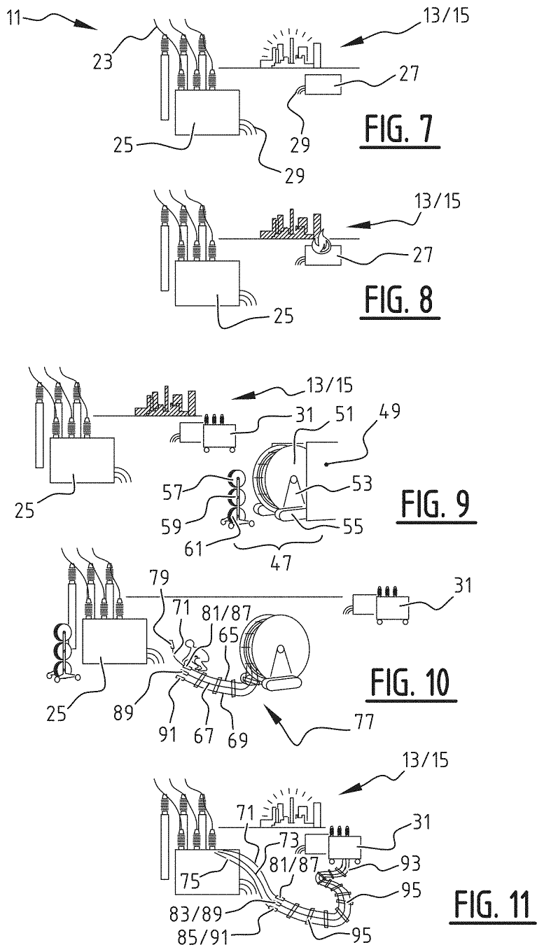

FIGS. 7 to 11 are illustrative of an embodiment of the method for temporarily installing single core power cables using a system according to the present invention for bypassing (faulty components of) a substation of an electricity (distribution) network during an outage.

FIGS. 7 and 8 correspond to FIGS. 2 and 3, respectively. In FIG. 7 substation 11 is schematically shown including a transformer 25 and a switchgear building 27. The transformer 25 is connected to intermediate voltage cables 21. The transformer 25 is furthermore connected to the switchgear building 27 via medium voltage cables 29. In FIG. 7, substation 11 is in operational state such that, as illustrated in FIG. 7, residential buildings 13 and industrial buildings 15 connected to the respective substations 11 and 12 are provided with electricity.

In FIG. 8 is again shown the situation wherein switchgear building 27 is faulty, resulting in an outage during which the residential buildings 13 and industrial buildings 15 connected to the respective substations 11 and 12 are no longer provided with electricity.

As shown in FIG. 9, for restoring the distribution of electricity to the residential buildings 13 and industrial buildings 15 a mobile emergency switchgear container 31 is provided for temporarily replacing the faulty switchgear building 27 while the faulty switchgear building 27 is being repaired. For electrically connecting the mobile emergency switchgear container 31 to the transformer 25, an embodiment 47 of a system according to the invention is delivered on site. The system 47 has an intermodal container 49 that is used to transport the system 47 to substation 11. In the intermodal container 49 the system 47 has an extension power cable reel 51 that, as shown, may be arranged on a self-propelled vehicle such as the shown vehicle 53 that runs on tracks 55. In the intermodal container 49 the system 47 also has three connector power cable reels 57, 59, 61 that, as shown, may be arranged on a cart 63.

Each of the connector power cables 71, 73, 75 wound on the respective connector cable reels 57, 59, 61, is at the other end thereof prepared for electrical connection to a respective one of the extension power cables 65, 67, 69 by being provided with a respective one electrical connector 81, 83, 85. The extension power cables 65, 67, 69 wound in parallel and in several windings upon the extension power cable reel 51, are each at one end thereof prepared for electrical connection to a respective one of the connector power cables 71, 73, 75 by being provided at that end thereof with a respective one electrical connector 87, 89, 91. Depending on the system, the connectors of the extension power cables 87, 89, 91 can be mating or non-mating with the connectors of the connector power cables 81, 83, 85 (in the latter case an extra connection joint is necessary).

As illustrated in FIG. 10, the extension power cable reel 51 is filled with three single core extension power cables 65, 67, 69, in particular single core medium voltage power cables, that are wound in parallel and in several windings upon the extension power cable reel 51 as a set 77 of single core extension power cables. Each of the connector power cable reels 57, 59, 61 is filled with at least one single core connector power cable 71, 73, 75 configured for electrically connecting an extension power cable to one of the electrical terminals of the transformer 25.

Each of the connector power cables 71, 73, 75 wound on the respective connector cable reels 57, 59, 61 is at one end thereof prepared for electrical connection to the terminals of the transformer 25, preferably by being provided with a termination or a connector 79 that is compatible with the terminals of the transformer 25. Each of the connector power cables 71, 73, 75 wound on the respective connector cable reels 57, 59, 61, is at the other end thereof prepared for electrical connection to a respective one of the extension power cables 65, 67, 69 by being provided with one 81, 83, 85 of two mating electrical connectors 81/87, 83/89, and 85/91. The extension power cables 65, 67, 69 wound in parallel and in several windings upon the extension power cable reel 51, are each at one end thereof prepared for electrical connection to a respective one of the connector power cables 71, 73, 75 by being provided at that end thereof with the other one 87, 89, 91 of the two mating electrical connectors 81/87, 83/89, and 85/91. Since the mating electrical connectors 81/87, 83/89, and 85/91 are already provided on the respective ends of the connector power cables 71, 73, 75 and the extension power cables 65, 67, 69, installation personnel only need to mate the mating electrical connectors 81/87, 83/89 on site in order to connect the connector power cables 71, 73, 75 to the extension power cables 65, 67, 69. And since each of the connector power cables 71, 73, 75 is at one end thereof already prepared for electrical connection to the terminals of the transformer 25, preferably by being provided with a termination or a connector 79 that is compatible with the terminals of the transformer 25, installation personnel only need to connect each termination or connector 79 on site to the respective terminals of the transformer 25 in order to connect the connector power cables 71, 73, 75 to the transformer 25. Relative to the prior art method illustrated in FIG. 5, there is no need to cut cables to length and to prepare the ends of the cables on site to be able to connect the cables to the transformer 25.

Alternatively, the connectors 81, 83, 85 of the connector power cables 71, 73, 75 may be non-mating with the connectors 87, 89, 91 of the extension power cables 65, 67, 69. In that case an extra connection joint is necessary for connecting the respective pairs of electrical connectors 81/87, 83/89, and 85/91.

Starting from the situation shown in FIG. 10, the set 77 of extension power cables 65, 67, 69 can be arranged along a path between the transformer 25 and the mobile emergency switchgear container 31 e.g. by moving the self-propelled vehicle 53 having arranged thereon the extension power cable reel 51 along the path while unwinding the extension power cables 65, 67, 69 as a set 77 of power cables. Thus in one run of the self-propelled vehicle 53 along a path between the transformer 25 and the mobile emergency switchgear container 31, three extension power cables 65, 67, and 69 are arranged on the ground surface 45 along said path between the transformer 25 and the mobile emergency switchgear container 31. Relative to the prior art method illustrated in FIGS. 5 and 6, there is no need to separately arrange three cables along a path between the transformer 25 and the mobile emergency switchgear container 31.

In the embodiment of the system 47 shown in FIGS. 9 to 11, the extension power cables 65, 67, 69, came on site wound in parallel and in several windings upon the extension power cable reel 51 as a set 77 of extension power cables 65, 67, 69, with the ends of the extension power cables 65, 67, 69 that are to be connected to the mobile emergency switchgear container 31, already prepared for electrical connection with the mobile emergency switchgear container 31. In particular, each of the set 77 of extension power cables 65, 67, 69 came prepared by being provided at one end thereof with electrical terminations or connectors 93 that are compatible with the electrical terminals of the mobile emergency switchgear container 31. Thus after arranging the set 77 of extension power cables 65, 67, 69 along the path between the transformer 25 and the mobile emergency switchgear container 31, installation personnel only needs to connect the electrical terminals of the mobile emergency switchgear container 31 to the compatible terminations or connectors 93 provided on the ends of the extension power cables 65, 67, 69 for electrically connecting the extension power cables 65, 67, 69, to the mobile emergency switchgear container 31. Alternatively, it is possible to provide the system 47 with an additional set of connector power cables like the connector power cables 71, 73, 75, for connecting the extension power cables 65, 67, 69 to the terminals of the mobile emergency switchgear container 31.

Furthermore, in the embodiment of the system 47 shown in FIGS. 9 to 11, the extension power cables 65, 67, 69 wound in parallel and in several windings upon the extension power cable reel 51 as a set 77 of extension power cables, are mutually joined in parallel relationship along the length of the extension power cables by means of a preinstalled set of corner length differential cable binders 95. The pre-installed cable binders 95 are configured to hold the extension power cables 65, 67, 69 mutually separated by a predefined distance. And the pre-installed cable binders 95 are configured for mutually joining the power cables short-circuit proof. Because of the pre-installed cable binders 95, after arranging the set 77 of three extension power cables 65, 67, and 69 on the ground surface 45 along a path between the transformer 25 and the mobile emergency switchgear container 31, it is no longer needed, relative to the prior art method discussed under reference to FIG. 6, to dig trenches and arrange the extension power cables therein.

After arranging the set 77 of extension power cables 65, 67, 69 mutually joined by the pre-installed cable binders 95 on the ground surface 45 along a path between the transformer 25 and the mobile emergency switchgear container 31, the single core extension power cables 65, 67, 69 can be connected to the terminals of the transformer 25 and the mobile emergency switchgear container 31 as described herein above, and the distribution of electricity to the residential buildings 13 and industrial buildings 15 can be restored as illustrated in FIG. 11.

In FIGS. 1 to 11 a mobile emergency switchgear container 31 is provided for temporarily replacing a faulty permanent switchgear building 27. Alternatively, it would also be possible to bypass the whole substation 11 by means of a mobile emergency substation that includes (a.o.) a transformer and a switchgear container.

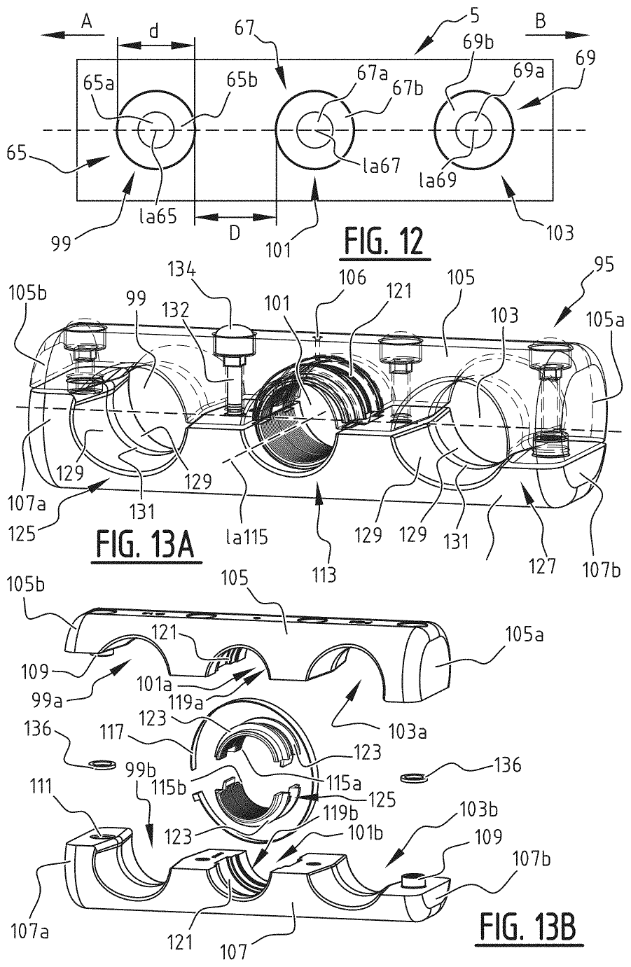

FIG. 12 is illustrative of the arrangement of the extension power cables 65, 67, 69 in the pre-installed cable binders 95. In FIG. 12 a pre-installed cable binder 97 is schematically shown having three cable accommodations 99, 101, 103. In FIG. 12 each of the cable accommodations 99, 101, 103 accommodates a respective one of the extension power cables 65, 67, 69. Each of the extension power cables 65, 67, 69, has a single core 65a, 67a, 69a enclosed by sheathing 65b. The cable accommodations 99, 101, 103 are arranged in a row such that the extension power cables 65, 67, 69 are arranged in a row. In particular, the extension power cables 65, 67, 69 are arranged in a row wherein the respective central longitudinal axes la65, la67, la69 are intersected by a line l that is perpendicular to at least one of the central longitudinal axes la65, la67, la69. The distance between neighbouring cable accommodations 99/101, 101/103 defines the distance d between neighbouring extension power cables 65/67, 67/69. In the shown preferred embodiment, the distance between neighbouring cable accommodations 99/101, 101/103 is such that the distance distance d between neighbouring extension power cables 65/67, 67/69 equals the diameter D of the extension power cables 65, 67, 69. The distance between the central longitudinal axes of neighbouring extension power cables thus equals 2d. Each of the cable accommodations 99, 101, 103, encloses a respective one of the extension power cables 65, 67, 69, thereby restricting movement of the extension power cables 65, 67, 69, relative to the pre-installed cable binder 97 in transverse direction relative to the respective central longitudinal axis la65, la67, la69, thereof. In case of a short-circuit the outer power cables 65 and 69 of the row are forced away from the middle power cable 67 in respective transverse directions A, B relative to the central longitudinal axis la67 of the middle power cable 67 as a result of electromechanical forces associated with the short-circuit. The pre-installed cable binder 95 is short-circuit proof by being designed to withstand the electromechanical forces in case of a three-phase short-circuit in the part of the electricity network where the set of extension power cables 65, 67, 69 are used. As a result, in case of a short-circuit, the pre-installed cable binder 95 holds the extension power cables 65, 67, 69 together despite the electromechanical forces associated with the short-circuit.

FIGS. 13A and 13B show a preferred embodiment of the pre-installed cable binder 95. The cable binder 95 is a fixed number cable binder designed for mutually joining in parallel a fixed number of power cables, in the shown embodiment three single core power cables. The cable binder 95 comprises set of two mating cable binder bodies 105, 107. Both cable binder bodies 105, 107 comprise three cable accommodations 99a, 99b, 101a, 101b, 103a, 103b. As shown in FIG. 13B, the cable accommodations 99a, 99b, 101a, 101b, 103a, 103b are configured to receive, in an unmated state of the mating cable binder bodies 105, 107, the power cables transverse to the central longitudinal axes of the power cables. In a mated state of the mating cable binder bodies 105, 107 respective pairs of cable accommodations 99a/99b, 101a/101b, 103a/103b, each pair comprising a cable accommodation of both mating cable binder bodies 105, 107, mate to form a single cable accommodation 99, 101, 103 that encloses the power cables received therein. Thus the power cables received in the cable accommodations 99a, 101a, 103a of one of the two mating cable binder bodies 105 are locked in the cable accommodations by means of the other one of the two mating cable binder bodies 107. The mating cable binder bodies 105, 107 are identical, which is an advantageous feature from a manufacturing point of view. The mating cable binder bodies 105, 107 are interlocking by each comprising on opposite sides of the accommodations 99, 101, 103 one of a protrusion 109 and a recess 111 that mate in the mated state of the cable binder bodies 105, 107. Furthermore, each of the mating cable binder bodies 105, 107 is provided with one long end wall 105a, 107a, and one short end wall 105b, 107b. In correspondence with the schematic arrangement of the power cables 65, 67, 69 shown in FIG. 12, in the mated state of the mating cable binder bodies 105, 107, that is shown in FIG. 13A, the extension power cables 65, 67, 69 received by the accommodations 99, 101, 103 are arranged in a row wherein the respective central longitudinal axes la65, la67, la69 are intersected by a line l that is perpendicular to at least one of the central longitudinal axes la65, la67, la69. As shown in FIG. 13A, in the mated state of the mating cable binder bodies 105, 107, the long end walls 105a are intersected by said line l.

The cable binder 95 shown in FIGS. 13A and 13B has a first cable coupling 113 that is configured to couple the cable binder 95 to the power cable 67 that is received in the middle cable accommodation 101 of the row of cable accommodations 99, 101, 103, such that translation of the power cable 67 received in the middle cable accommodation 101 relative to the cable binder 95 in longitudinal direction of the power cable 67 is blocked. The first cable coupling 113 is further configured to couple the cable binder 95 to the power cable 67 received in the middle cable accommodation 101 of the row of cable accommodations 99, 101, 103, such that rotation of the power cable 67 relative to the cable binder 95 about the central longitudinal axis la67 of the power cable 67 is allowed. In the preferred embodiment shown in FIGS. 13A and 13B, the first cable coupling 113 comprises a clamping bush 115 that is configured to be clamped on the power cable 67. In particular the clamping bush 115 is made out of two mating halves 115a, 115b, that can be arranged around the circumference of a power cable 67, and can be clamped upon the outer surface of the sheathing 67b of power cable 67 by means of a strap 117. The inner surface of the halves 115a, 115b that are brought into contact with the outer surface of the sheathing 67b of power cable 67 is provided with ribs, such that translation of the clamping bush 115 along the power cable 67 is blocked once the clamping bush 115 is clamped upon the power cable 67. The mating cable binder bodies 105, 107 are each provided with a clamping bush accommodation 119a, 119b for accommodating the clamping bush 115 therein. In the mated state of the mating cable binder bodies 105, 107 the clamping bush accommodations 119a, 119b provide a assembled clamping bush accommodation 119 with cylindrical surfaces that mate with the cylindrical outer surface of clamping bush 115. The mating cylindrical surfaces of the assembled clamping bush accommodation 119 and the clamping bush 115 received therein allow for the clamping bush 115 to rotate in the clamping bush accommodation 119 about the central longitudinal axis la115 of the clamping bush 115. In the mated state of the cable binder bodies 105, 107 the cylindrical surface of the clamping bush accommodation 119 has a circumferential groove 121 into which one or more circumferential walls 123 on the cylindrical outer surface of clamping bush 115 protrude with the clamping bush 115 accommodated in the assembled clamping bush accommodation 119. The circumferential groove 121 and the preferably two circumferential walls 123 cooperate to block translation of the clamping bush 115 relative to the assembled clamping bush accommodation 119 along the central longitudinal axis la115 of the clamping bush 115, while allowing for the clamping bush 115 to rotate in the clamping bush accommodation 119 about the central longitudinal axis la115 of the clamping bush 115. For clamping the clamping bush 115 upon the outer surface of the sheathing 67b of power cable 67, one or more straps 117 are used in the circumferential groove 125 between the two circumferential walls 123. Instead of the clamping bush having two circumferential walls 123 that protrude from the cylindrical outer surface of clamping bush 115 and into a circumferential groove 121 of the cylindrical surface of the assembled clamping bush accommodation 119, it is possible that the two circumferential walls 123 of the clamping bush 115 are positioned further apart, thereby forming a circumferential groove there between in which the mating cable binder bodies 105, 107 extend.

The cable binder 95 further comprises two second cable couplings 125, 127, that are configured to couple the cable binder 95 to the power cables 65, 69 that are received in the two outer cable accommodations 99, 103 of the row of cable accommodations 99, 101, 103, such that translation of the power cables 65, 69 relative to the cable binder 95 in longitudinal direction of the power cables 65, 69 is allowed. In the preferred embodiment shown in FIGS. 13A and 13B, the second cable couplings 125, 127 comprises the cylindrical cable accommodations 99, 103 for accommodating the power cables 65,69 therein. The cylindrical cable accommodations 99, 103 are venturi tube shaped, with entrance cones 129 defining a throat 131 there in between. In an advantageous embodiment (not shown) a low friction ring is arranged in the throat 131 of the venturi tube shaped cable accommodations 99, 103.

As shown in FIG. 13A the mating cable binder bodies 105, 107 are held together in the mated state by means of carriage bolts 132 with a raised head 134. The height of the raised head 134 is such that the raised head 134 protrudes from the cable binder body 105, thereby serving as a wear part. The latter is in particular advantageous when the set 77 of power cables is pulled along a path over the ground. In order to use the raised heads 134 as a wear part when pulling the set 77 of power cables over the ground, the cable binder 95 is arranged upside down relative to the orientation shown in FIG. 13A, such that the raised heads 134 are in contact with the ground surface.

As shown in FIG. 13B spacer rings 136 can be arranged between the mating cable binder bodies 105, 107. This allows to adapt the clamping bush accommodation 119 and the circumferential groove 121 of the clamping bush 115 received therein resepectively.

As shown in FIG. 13A the cable binder body 105 is provided with a through hole 106 that may be used to flush dirt out of the circumferential groove 121.

As shown in FIGS. 13A and 13B, the mating cable binder bodies 105, 107, have rounded edges. This prevents the cable binders 95 getting caught on something while the set 77 of single core power cables is being pulled along a path. Preferably, in the mated state, the cable binder bodies 105, 107 provide the cable binder 95 with a pebble shape, and thereby make for a pebble shaped cable binder 95.

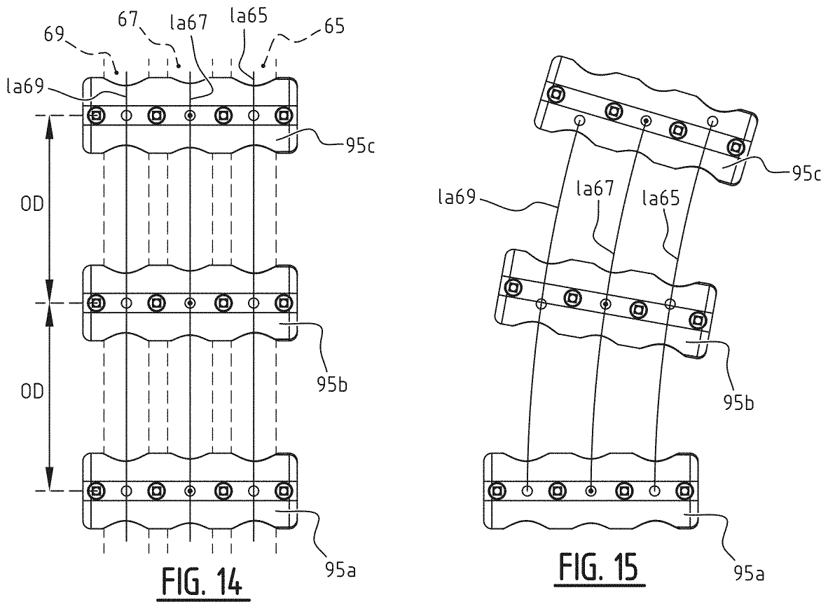

In FIG. 14 a part of the length of the set 77 of the extension power cables 65, 67, 69 is shown, along which length the extension power cables 65, 67, 69 are mutually joined by means of three of the pre-installed cable binders 95. As shown the respective pre-installed cable binders 95a, 95b, 95c, are distributed along the shown length such that neighbouring preinstalled cable binders 95a/95b, 95b/95c are mutually offset in longitudinal direction of the power cables 65, 67, 69 over an offset distance OD. In FIG. 14 is schematically shown with circles locations along the central longitudinal axes la65, la67, la69, where the respective cable binders 95a, 95b, 95c are coupled to the power cables 65, 67, 69 in case, as shown in FIG. 14, the power cables 65, 67, 69 are arranged along a straight path. The open circles indicate locations where the power cables 65, 67, 69 are coupled to the cable binders 95a, 95b, 95c by means of the second couplings 125, 127 such that translation of the respective power cable 65, 67, 69 relative to the respective cable binder 95a, 95b, 95c is allowed. The open circles with a dot inside, indicate locations where the power cables 65, 67, 69 are coupled to the cable binders 95a, 95b, 95c by means of the first coupling 113 such that translation of the respective power cable 65, 67, 69 relative to the respective cable binder 95a, 95b, 95c in longitudinal direction of the power cables is blocked.

In FIG. 15 the part of the length of the set 77 of the extension power cables 65, 67, 69 is shown in case the length is arranged along a curved path. As shown in FIG. 15 the open circles with a dot inside, that indicate locations where the power cables 65, 67, 69 are coupled to the cable binders 95a, 95b, 95c by means of the first coupling 113 such that translation of the respective power cable 65, 67, 69 relative to the respective cable binder 95a, 95b, 95c in longitudinal direction of the power cables is blocked, remain on the same location relative to the respective cable binder 95a, 95b, 95c when the part of the length of the set 77 of the extension power cables 65, 67, 69 of FIG. 14 is arranged along a curved path. However, as shown in FIG. 15, as a result of the difference in length of the paths of the respective power cables 65, 67, 69 along the curved path, the open circles that in FIG. 14 indicated locations where the power cables 65, 67, 69 were coupled to the cable binders 95a, 95b, 95c by means of the second cable couplings 125, 127 have moved relative to the respective cable binder 95a, 95b, 95c, thereby compensating for the difference in length of the paths of the respective power cables 65, 67, 69 along the curved path.

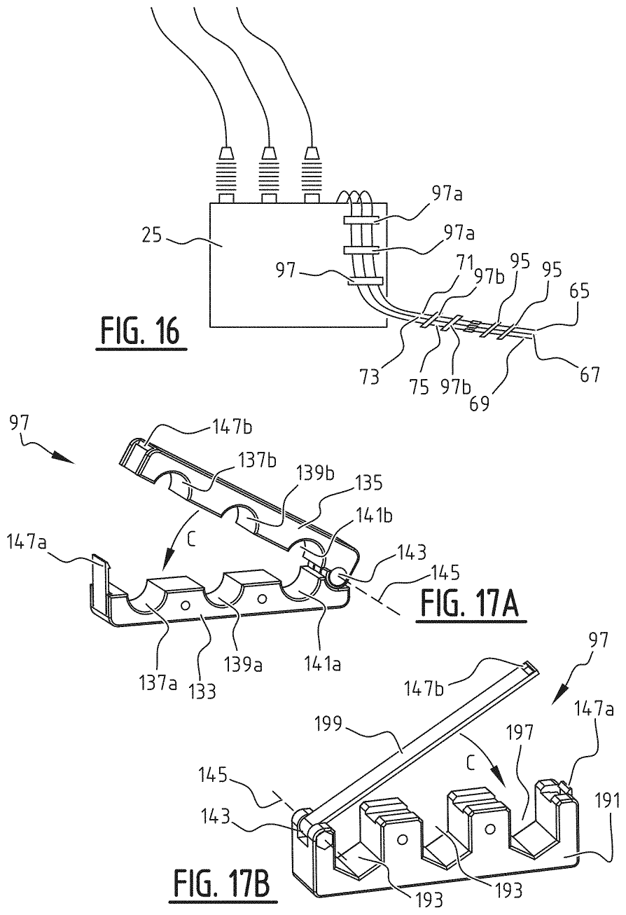

In FIG. 16 is shown that the connector power cables 71, 73, 75 that electrically connect the extension power cables 65, 67, 69 to the transformer 25 have been mutually joined in parallel relationship by means of post-installed cable binders 97. As shown in FIG. 16, the connector power cables 71, 73, 75 are joined together by means of post-installed cable binders 97a along a raised part of the length of the connector power cables 71, 73, 75 that hangs off the transformer 25. Furthermore, the connector power cables 71, 73, 75 are joined together by means of post-installed cable binders 97b along a part of the length of the connector power cables 71, 73, 75 that is arranged on the ground. Post-installed cable binders 97 will be described in more detail herein below under reference to FIGS. 17 to 24.

In FIG. 17A an embodiment is shown of the post-installed cable binder 97. The cable binder 97 is a fixed number cable binder designed for mutually joining in parallel a fixed number of power cables, in the shown embodiment three single core power cables. The cable binder 97 comprises set of two mating cable binder bodies 133, 135. Both cable binder bodies 133, 135 comprise three cable accommodations 137a, 137b, 139a, 139b, 141a, 141b. As shown in FIG. 17A, the cable accommodations 137a, 137b, 139a, 139b, 141a, 141b are configured to receive, in an unmated state of the mating cable binder bodies 133, 135, the power cables transverse to the central longitudinal axes of the power cables. The mating cable binder bodies 133, 135 are connected by means of a hinge 143 such that the mating cable binder bodies are rotatable the one relative to the other between the unmated state shown in FIG. 17A and a mated state. By rotating the cable binder body 135 about the axis of rotation 145 relative to the other cable binder body 133 in the direction of arrow C the mating cable binder bodies 133 and 135 can be brought into the mated state. In a mated state of the mating cable binder bodies 133, 135 respective pairs of cable accommodations 137a/137b, 139a/139b, 141a/141b, mate to form a single cable accommodation 137, 139, 141 that encloses the power cables received therein. Thus the power cables received in the cable accommodations 137a, 139a, 141a of one of the two mating cable binder bodies 133 are locked in the cable accommodations 137b, 139b, 141b of the other one of the two mating cable binder bodies 135 after rotating the other one of the two mating cable binder bodies 135 in the direction of arrow C. The embodiment of the post-installed cable binder 97 shown in FIG. 17A is provided with a quick fastener comprising two cooperating parts 147a, 147b that engage each other in the mated state of the two mating cable binder bodies 135, 137. Because of its hinge 145 and quick fastener 147a/147b the embodiment of the post-installed cable binder body 97 shown in FIG. 17 is also referred to as quick-fastener cable binder. The embodiment of a cable binder 97 as shown in FIG. 17A is in particular suitable to join free hanging power cables. The embodiment of a cable binder 97 as shown in FIG. 17A thus is preferably used as post-installed cable binder 97a that is shown in FIG. 16.

In FIG. 17B an alternative embodiment is shown of the quick-fastener cable binder shown in FIG. 17A. The cable binder 97 shown in FIG. 17B is a fixed number cable binder designed for mutually joining in parallel a fixed number of power cables, in the shown embodiment three single core power cables. The cable binder 97 comprises a single cable binder body 191. The binder body 191 comprises three cable accommodations 193, 195, 197. As shown in FIG. 17B, the cable accommodations 193, 195, 197 are configured to receive the power cables transverse to the central longitudinal axes of the power cables. The cable binder 97 comprises a locking member embodied by a strip 199 for locking the power cables in the accommodations 193, 195, 197. The cable binder body 191 and the locking strip 199 are connected by means of a hinge 143 such that the cable binder body 191 and the locking strip 199 are rotatable the one relative to the other between an unlocked state shown in FIG. 17B and a locked state. By rotating the locking strip 199 about the axis of rotation 145 relative to the cable binder body 191 in the direction of arrow C the cable binder body 191 and the locking strip 199 can be brought into the locked state. The embodiment of the post-installed cable binder 97 shown in FIG. 17B is provided with a quick fastener comprising two cooperating parts 147a, 147b that engage each other in the locked state of the cable binder body 191 and the locking strip 199. The embodiment of a cable binder 97 as shown in FIG. 17B is in particular suitable to join power cables that lay free on the ground. The embodiment of a cable binder 97 as shown in FIG. 17B thus is preferably used as post-installed cable binder 97b that is shown in FIG. 16. The cable binder 97 shown in FIG. 17B will generally be used upside down relative to the orientation shown in FIG. 17B. The locking strip 199 is in use slid underneath three single core power cables, and subsequently, the cable binder body 191 is rotated about the axis of rotation 145 toward the locking strip 199 and the single core power cables such that the single core power cables enter the cable accommodations 193, 195, 197 and are locked in the cable accommodations 193, 195, 197 once the cable binder body 191 and the locking strip 199 are in the locked state. Alternatively, in stead of the hinge 143, a second quick fastener may be used to fasten the locking strip 199 to the cable binder body 191 in the locked state of the cable binder body 191 and the locking strip 199.

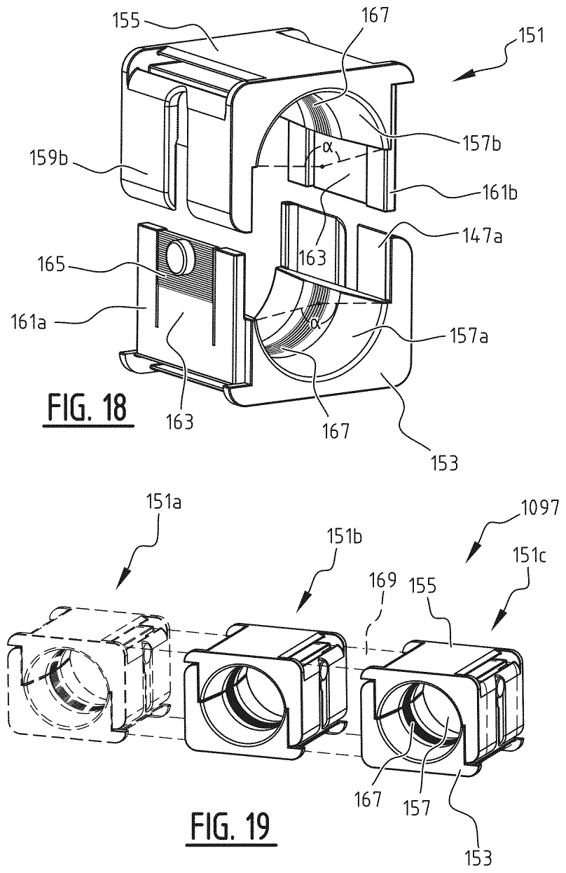

In FIGS. 18 and 19 an alternative embodiment 1097 of the post-installed cable binder 97 is shown. Modular cable binder 1097, shown in FIG. 19, comprises three cable binder modules 151a, 151b, and 151c, that are each configured to accommodate one power cable. As shown in FIG. 18 each cable binder module 151 comprises a set of two mating cable binder bodies 153, 155. Both mating cable binder bodies 153, 155 have a cable accommodation 157a, 157b for one power cable. The cable accommodations 157a, 157b are configured to receive a power cable transverse to the longitudinal direction of the power cables in an unmated state of the mating cable binder bodies shown in FIG. 18. In a mated state of the mating cable binder bodies 153, 155 the respective cable accommodations 157a, 157b of the mating cable binder bodies 153, 155 mate to form a single cable accommodation 157 that encloses the power cable received therein. Thus the power cable received in the cable accommodation 157a of one of the two mating cable binder bodies 153 is locked in the cable accommodation 157b of the other one of the two mating cable binder bodies 155. The mating cable binder bodies 153, 155 are identical, which is an advantageous feature from a manufacturing point of view. The mating cable binder bodies 153, 155 are interlocking. In particular the mating cable binder bodies 153, 155 each comprise two side walls 159a, 159b; 161a, 161b that extend on opposite sides of the respective cable accommodation 157a, 157b. In the mated state each side wall 159a, 159b of one of the cable binder bodies 153 mates with one of the side walls 161a, 161b of the other one of the cable binder bodies 155 in parallel relationship wherein one of the mating side walls 161a, 161b nests in the other one of the side walls 159b, 159a. As shown in FIG. 18, the side walls 161a, 161b have been provided with a lip 163 having a set of ribs 165 arranged on an outward facing surface thereof. The set of ribs 165 cooperates with a set of ribs (not shown) on an inward facing surface of the other side walls 159a, 159b, such that in the mated state of the cable binder bodies 153, 155 the respective sets of ribs engage each other, thereby locking the cable binder bodies 153, 155 the one relative to the other in the mated state thereof. The locking of the cable binder bodies 153, 155 the one relative to the other in the mated state thereof by means of the sets of ribs provided on the side walls, allows for clamping the cable binder module 151 on a power cable, in particular on the outer sheath of the power cable. When clamped on a power cable, ribs 167 provided on an inside surface of the cable accommodation 157 prevents translation of the cable binder module 151 in longitudinal direction along the power cable. The respective cable accommodations 157a, 157b of the mating cable binder bodies 153, 155 have an arced inner contact surface that contacts the sheathing of the power cable accommodated in the cable accommodations. The central angle α of the arced inner contact surface is less than 180°, thereby allowing the cable binder module 151 to be clamped on power cables having different outer diameters.

As illustrated by means of FIG. 19, three power cables can be mutually joined, by clamping a respective cable binder module 151 on a respective power cable of a set of three parallel power cables, such that the cable binder modules 151a, 151b, 151c are arranged in a row, and by subsequently binding the cable binder modules 151a, 151b, 151c together by means of a strap 169. As shown in FIG. 19 the cable binder modules 151a, 151b, 151c are arranged in parallel, i.e. the cable binder bodies 153 of the cable binder modules are arranged in a first row, while the cable binder bodies 155 of the cable binder modules are arranged in a second row. As shown in FIG. 19 wherein the cable binder modules 151a, 151b, 151c are not in mutual contact. Although it is possible, it is not required to pull neighbouring cable binder modules 151a/151b; 151b/151c the one against the other. Instead of mutually joining three power cables, the modular cable binder 1097 can be configured to mutually join less or more power cables by decreasing or increasing the number of cable binder modules 151 that is strapped together by means of the strap 169. The embodiment of a cable binder 1097 as shown in FIG. 19 is in particular suitable to join free hanging power cables. The embodiment of a cable binder 1097 as shown in FIG. 19 thus is preferably used as post-installed cable binder 97a that is shown in FIG. 16. The cable binder 1097 shown in FIG. 19 has as a particular advantage that it allows for mutually joining free hanging single core power cables at variable mutual distances.

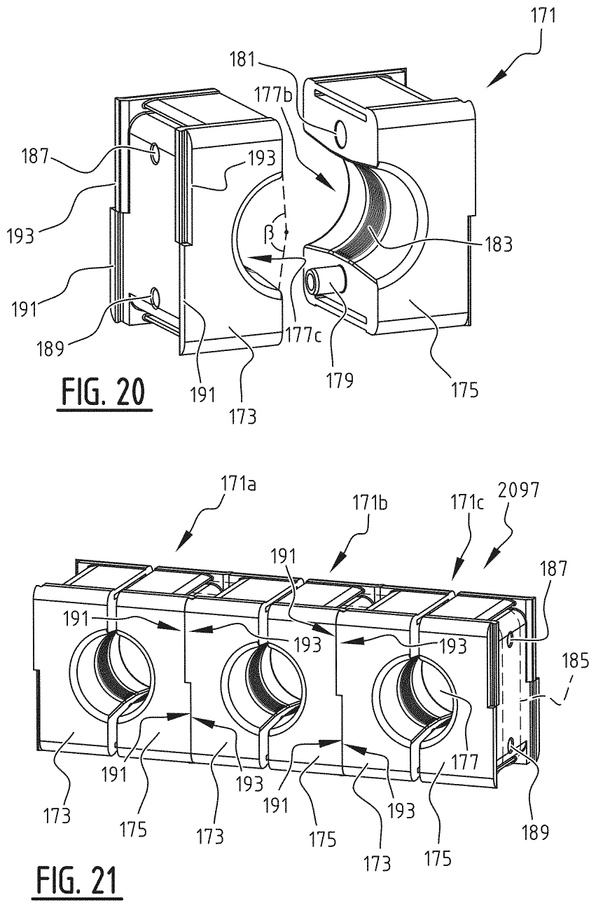

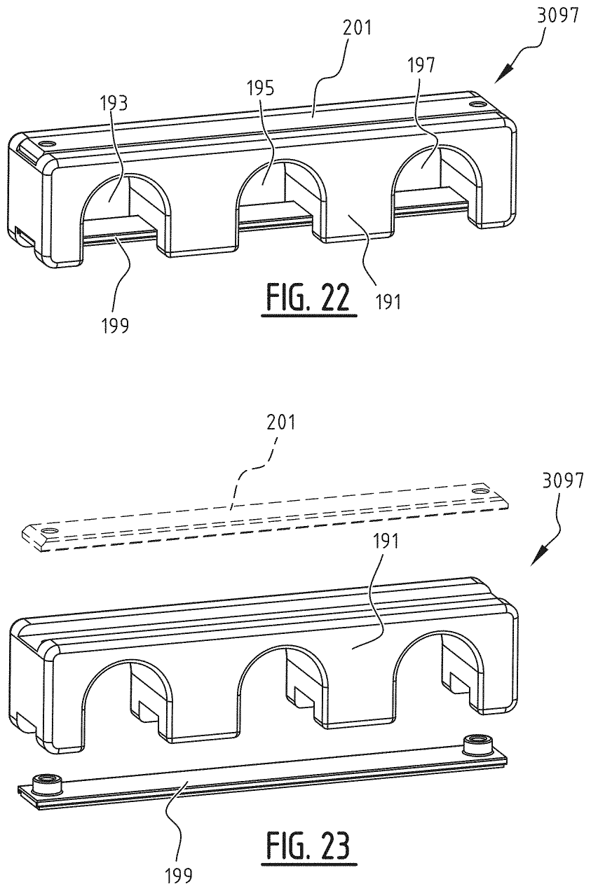

In FIGS. 20 and 21 an alternative embodiment 2097 of the post-installed cable binder 97 is shown. Modular cable binder 2097, shown in FIG. 21, comprises three cable binder modules 171a, 171b, and 171c, that are each configured to accommodate one power cable. As shown in FIG. 21 each cable binder module 171 comprises a set of two mating cable binder bodies 173, 175. Both mating cable binder bodies 173, 175 have a cable accommodation 177a, 177b for one power cable. The cable accommodations 177a, 177b are configured to receive a power cable transverse to the longitudinal direction of the power cables in an unmated state of the mating cable binder bodies shown in FIG. 22. In a mated state of the mating cable binder bodies 173, 175 the respective cable accommodations 177a, 177b of the mating cable binder bodies 173, 175 mate to form a single cable accommodation 177 that encloses the power cable received therein. Thus the power cable received in the cable accommodation 177a of one of the two mating cable binder bodies 173 is locked in the cable accommodation 177b of the other one of the two mating cable binder bodies 175. The mating cable binder bodies 173, 175 are identical, which is an advantageous feature from a manufacturing point of view. The mating cable binder bodies 173, 175 are interlocking. In particular the mating cable binder bodies 173, 175 are interlocking by each comprising on opposite sides of the accommodations 177a, 177b one of a protrusion 179 and a recess 181 that mate in the mated state of the cable binder bodies 173, 175. The respective cable accommodations 177a, 177b of the mating cable binder bodies 173, 175 have an arced inner contact surface that contacts the sheathing of the power cable accommodated in the cable accommodations. The central angle β of the arced inner contact surface is less than 180°, thereby allowing the cable binder module 171 to be clamped on power cables having different diameter. Spacers, such as spacer rings (not shown), can be arranged on the protrusions 179 for defining the distance between the mating cable bodies 173, 175, and thereby defining whether or not the cable binder module 171 clamps on a power cable or only loosely holds to the power cable when the power cable is arranged in the accommodation 177 and the mating cable binder bodies 173, 175 are pushed the one towards the other. When clamped on a power cable, ribs 183 provided on an inside surface of the cable accommodation 177 prevents translation of the cable binder module 171 along the power cable.

As shown in FIG. 21 the cable binder modules 171a, 171b, 171c are arranged in a row in series, i.e. the cable binder bodies 173 and 175 are arranged in a single row. After arranging the cable binder modules 171a, 171b, 171c in a row, the cable binder modules 171a, 171b, 171c can be bound together by means of a strap 185. Alternatively, the cable binder modules 171a, 171b, 171c are bound together by means of a u-shaped fastener. As shown in FIG. 20 each of the cable binder modules 171 two through holes 187, 189 that extend through the recesses 181 and the protrusions 179. The through holes of the cable binder modules are aligned when the cable binder modules 171a, 171b, 171c are arranged in a row as shown in FIG. 21. Subsequently, a U-shaped fastener (not shown) can extend through the aligned through holes 187, 189 and hold the cable binder modules 171a, 171b, 171c together instead of the strap 185.

As shown in FIGS. 20 and 21, the cable binder bodies 173, 175 are provided with dove tail profiles 191, 193, that allow in the row of cable binder modules 171a, 171b, 171c, for mutually coupling neighbouring cable binder bodies 173, 175 of different cable binder modules 171.

The embodiment of a cable binder 2097 as shown in FIG. 21 is in particular suitable to join free hanging power cables. The embodiment of a cable binder 2097 as shown in FIG. 21 thus is preferably used as post-installed cable binder 97a that is shown in FIG. 16. In case the mating cable bodies 173, 175 of the respective modules 171a, 171b, 171c are individually bound together by means of a respective U-shaped fastener and the respective modules 171a, 171b, 171c are bound together by means of the strap 185, it is possible to use the cable binder 2097 for mutually joining free hanging single core power cables at variable mutual distances

As described herein above, spacers, such as spacer rings (not shown), can be arranged between the mating cable binder bodies 173, 175 and around the protrusions 179 for defining the distance between the mating cable binder bodies 173, 175, and thereby defining whether or not the cable binder module 171a, 171b, 171c, clamps on a power cable or only loosely holds to the power cable when the power cable is arranged in the accommodation 177 and the mating cable binder bodies 173, 175 are pushed the one towards the other. By providing spacers in the cable binder 2097 shown in FIG. 21 between the cable binder bodies 173, 175 of the outer cable binder modules 171a and 171c, such that the outer cable binder modules 171a and 171c hold the power cables arranged therein loosely and by omitting spacers between the cable binder bodies 173, 175 of the middle cable binder module 171b, the middle cable binder module 171b is clamped on the middle power cable. Alternatively by providing spacers in the cable binder 2097 between the cable binder bodies 173, 175 of the middle cable binder module 171b and by arranging a clamping bush between the cable binder bodies 173, 175 of the middle cable binder module 171b that is clamped on the middle power cable that is held by the middle cable binder 171b and that is allowed to rotate relative to the middle cable binder module 171b while blocking translation of the middle power cable relative to the middle cable binder module 171b in longitudinal direction, a cable binder 2097 is provided that provides the same functionality as the pre-installed cable binder 95 shown in FIGS. 13A and 13B.

In FIGS. 22 and 23 an alternative embodiment 3097 of the post-installed cable binder 97 is shown. The cable binder 3097 is a fixed number cable binder designed for mutually joining in parallel a fixed number of power cables, in the shown embodiment three single core power cables. The cable binder 3097 comprises a single cable binder body 191. The binder body 191 comprises three cable accommodations 193, 195, 197. As shown in FIG. 23, the cable accommodations 193, 195, 197 are configured to receive the power cables transverse to the central longitudinal axes of the power cables. The cable binder 3097 comprises a locking member embodied by a strip 199 for locking the power cables in the accommodations 193, 195, 197. An optional strip 201 may be provided on the side of the cable binder body 191 opposite the locking strip 199 to add strength to the cable binder body 191. The cable binder 3097 and strip(s) 199 (201) can be put together by means of fasteners (not shown) that can extend through the through holes at both sides of the cable binder 3097 and subsequently be screwed into the locking strip 199. Alternatively to the (standard) fasteners quick fasteners may be used. The embodiment of a cable binder 3097 as shown in FIGS. 21 and 23 is in particular suitable to join power cables that lay free on the ground. The embodiment of a cable binder 3097 as shown in FIGS. 21 and 23 thus is preferably used as post-installed cable binder 97b that is shown in FIG. 16.

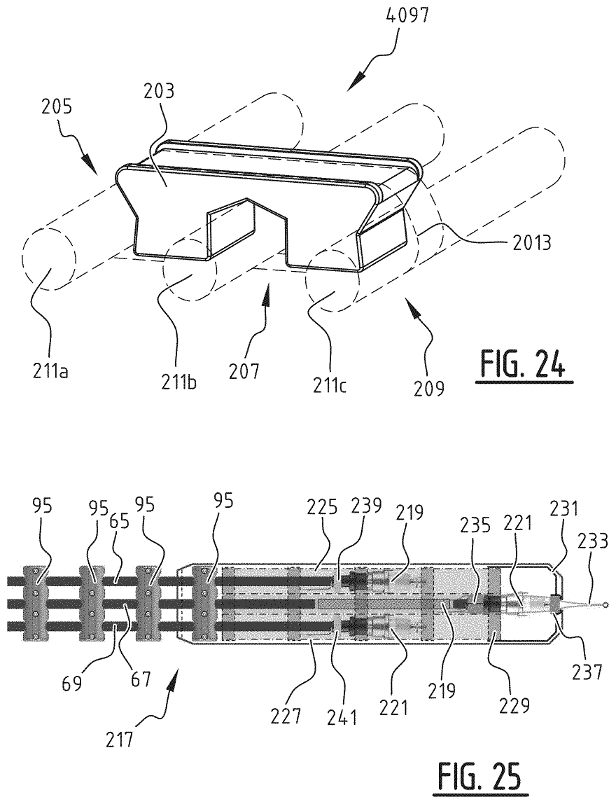

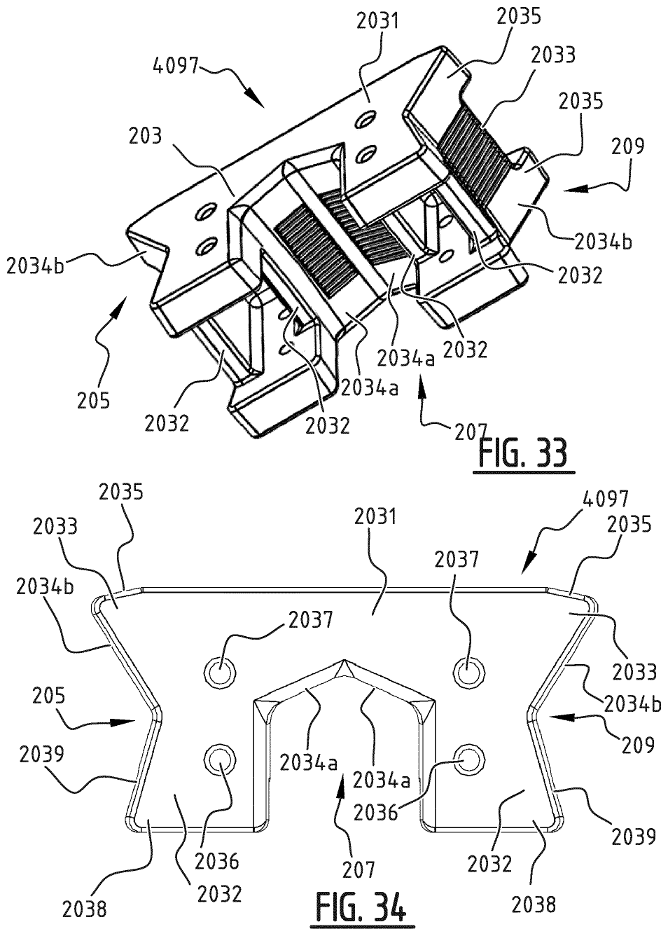

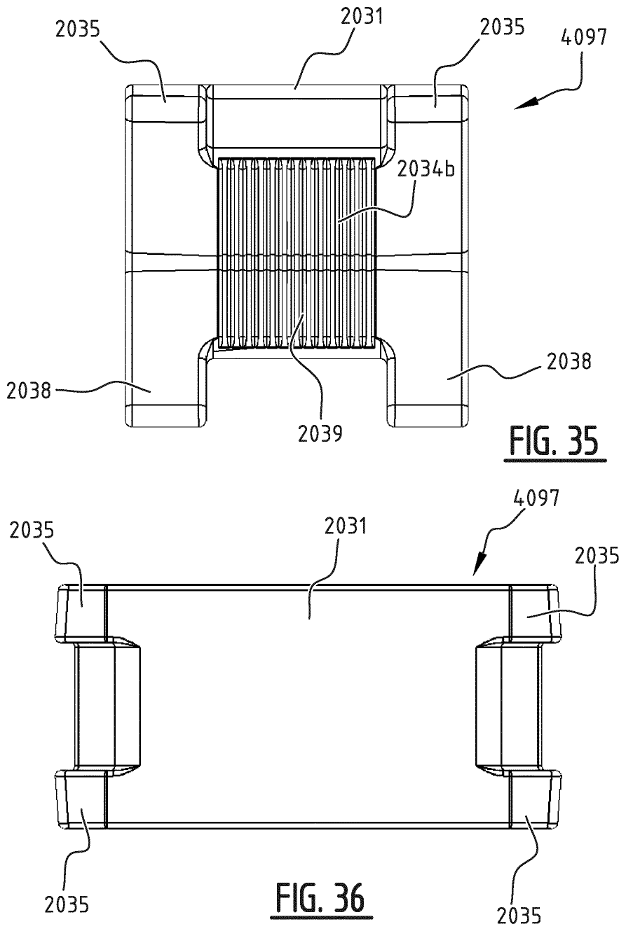

In FIG. 24 and FIGS. 33-40 an alternative embodiment 4097 of the post-installed cable binder 97 is shown. The cable binder 4097 is a fixed number cable binder designed for mutually joining in parallel a fixed number of power cables, in the shown embodiment three single core power cables 211a, 211b, 211c. The cable binder 4097 comprises a single cable binder body 203. The cable binder body 203 comprises three cable accommodations 205, 207, 209. The cable accommodations 205, 207, 209 are configured to receive the power cables transverse to the central longitudinal axes of the power cables 211a, 211b, 211c. The cable binder 4097 comprises a locking member embodied by a strap 2013 for locking the power cables in the accommodations 205, 207, 209. The embodiment of a cable binder 4097 as shown in FIG. 24 is suitable to join power cables that hang free in the air (e.g. off a transformer) or lay free on the ground. In order to prevent the cable binder 4097 from sliding downwards when hanging free in the air additional screw-holes 2036 can be provided between the cable accommodations 205, 207 and 207, 209 to hook up the cable binder. The embodiment of a cable binder 4097 as shown in FIG. 24 and FIGS. 33-40 thus is preferably used as post-installed cable binder 97a or as post-installed cable binder 97b that is shown in FIG. 16.

The cable binder body 203 comprises an elongated main body part 2031, wherein two divider walls 2032 extend from one side of the main body part 2031 at a distance from the outer ends 2033 of the main body part 2031. Cable accommodation 207 is formed by the adjacent two divider walls 2032 and the part of the main body part 2031 extending between divider walls 2032. The two other cable accommodations 205, 209 are each formed by one of said divider walls 2032 and the adjacent outer end of the main body part 2031. The main body part 2031 is provided with oblique wall parts 2034a, 2034b adjacent the divider walls 2032. The outer wall parts 2034b of the main body part 2031 may extend at an angle of approximately 60 degrees with the top surface of the main body part 2031. The inner wall parts 2034a may extend at an angel of approximately 30 degrees with the top surface of the main body part. The outer wall parts 2039 of the divider wall 2032 adjacent the outer wall parts 2034b may extend at an angle of 60 degrees with the top surface of the main body part in the opposite direction. The wall parts 2034a, 2034b and 2039 engage the cables 211a, 211b, 211c. The angle between the wall part 2034 and the wall part 2039 is approximately 120 degrees (preferably somewhere between 100 and 150 degrees, most preferably approximately 132 degrees). Similarly, the angle between both wall parts 2034a of the main body between the divider walls 2032 is also approximately 120 degrees (preferably somewhere between 100 and 150 degrees, most preferably approximately 132 degrees). The wall parts 2034a, 2034b and 2039 are preferably provided with a profiled or rough surface, in order to prevent slipping of the cables 211a, 211b, 211c.

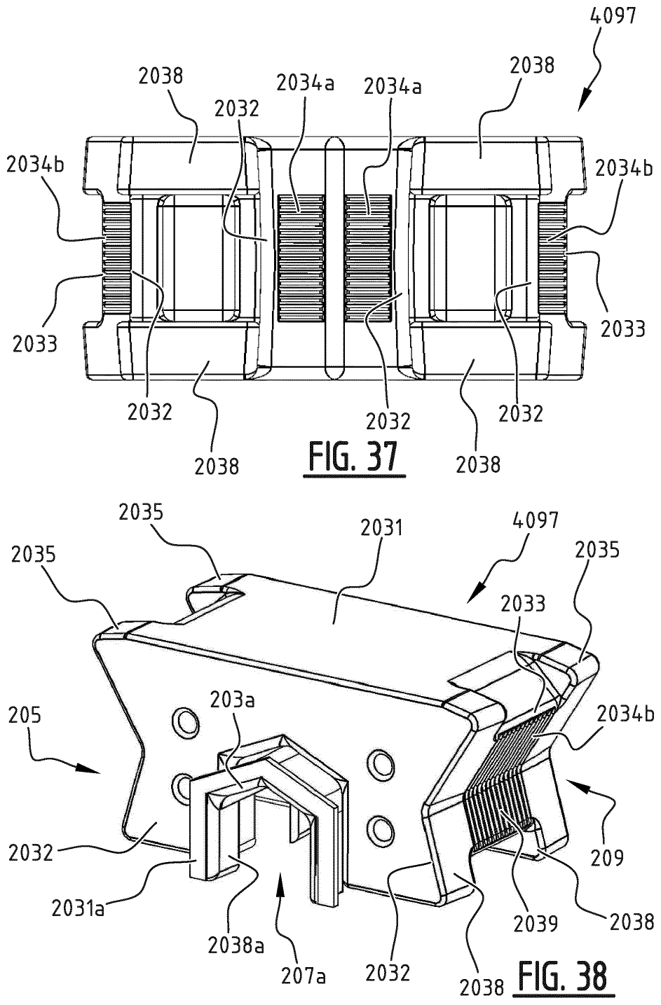

The surfaces of the wall parts 2034a, 2034b and 2039, as well as other parts of the divider walls, such as the inner surfaces of the divider walls 2032, which may engage the cables surfaces, preferably have a convex shape, as shown in FIG. 37, such that the cable binder body does not damage the cables when used in a bent.

The distance between the outer ends of the two adjacent wall parts 2034a (which is also the distance between the divider walls) is preferably approximately the same as or slightly larger than the diameter of the cables 211a, 211b, 211c. Similarly, the distance between the outer ends of the adjacent wall parts 2034b and 2039 is preferably approximately the same as the diameter of the cables 211a, 211b, 211c. As an example, in order to accommodate single core power cables having a diameter between 36 mm and 54 mm, the distance between the divider walls 2032 should be at least 54 mm. Typically the single core power cables have a diameter between 36 mm and 54 mm. In case smaller diameter cables are used, a filling piece 203a may be inserted in the cable accommodation 207, as shown in FIG. 38. The filling piece 203a has a secondary, smaller cable accommodation 207a having substantially the same shape as the cable accommodation 207 in which it is inserted. The filling piece 203a is provided with positioning means 2031a, in this embodiment shown as a flange, which holds the filling piece 203a in place once the system is mounted.

The locking member is a strap 2013 which is wound around the main body part 2031 and the divider walls 2032 while the power cables 211a, 211b, 211c are present in the cable accommodations 205, 207, 209. The top side of the main body part 2031 of the cable binder body 203 is provided with strap guiding means 2035, for preventing lateral movement of the strap 2013, which as shown in FIG. 24 may be in the form of upright side ridges 2035, or as shown in FIGS. 33-40, may be in the form of separate protrusions 2035 near the four outer ends on the sides of the top surface of the main body part.

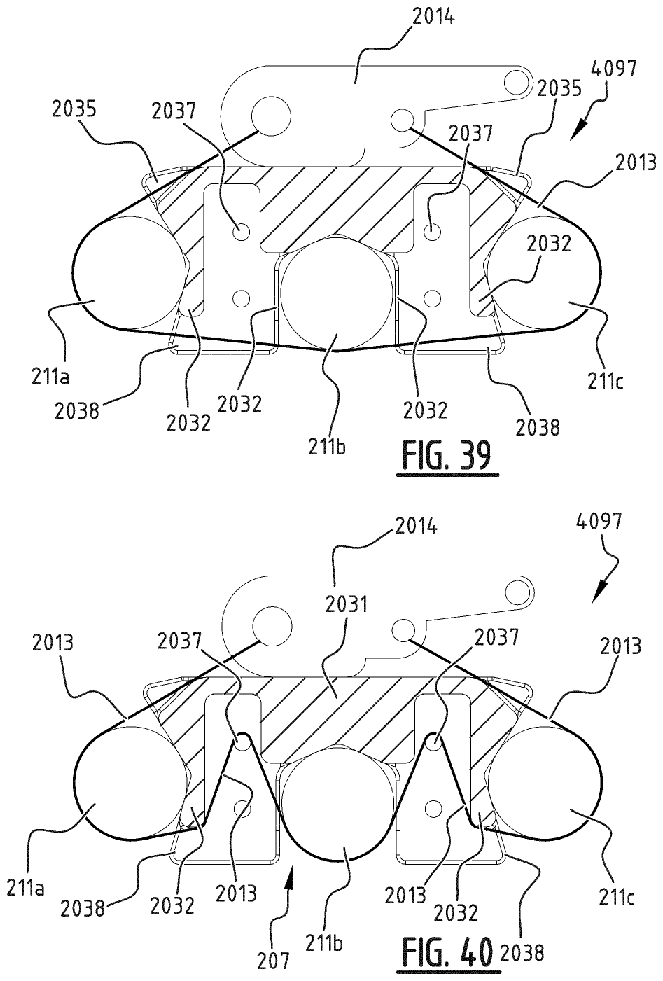

Strap holders 2037 as shown in FIGS. 39 and 40 may be provided inside the central cable accommodation 207, which strap holders 2037 are arranged to hold said strap 2013 inside the cable accommodation 207 on either side of the power cable 211b, as shown in FIG. 40, thereby firmly engaging said power cable 211b and pulling the power cable 211b against the main body part 2031 of the cable binder body 203. Said strap holders 2037 my be for instance in the form of bars, for instance formed by bolts extending through holes in the cable binder body, extending in parallel inside the cable accommodation 207, one on each side of the power cable 211b, wherein the strap 2013 is guided in a zig-zag manner inside the cable accommodation 207, first through the space between said strap holder and the main body part 2031 on one side of the power cable 211b, then around the power cable 211b, and then through the space between said strap holder and the main body part 2031 on the other side of the power cable 211b.

As can be seen in FIG. 33, legs 2038 extend down from the divider walls 2032 on each side of the strap 2013, which, as can be seen in FIGS. 39 and 40, are sufficiently high in order to prevent that the cable 211b touches a surface below the cable binder body 203 Similarly the filling piece 203a is provided with legs 2038a.

The strap 2013 is closed and locked by means of a fast closing buckle 2014. The LC2 strength of the straps is preferably larger than 13 kN, more preferably more than 20 kN, more preferably more than 40 kN, for each 1 meter of length of the cable system, in order to withstand the EM-forces that may be caused by the short circuit currents in the cable system. Preferably the strap is made of a slightly elastic material, such that it can absorb mechanical shocks caused by such currents, thereby preventing damage to the cables.

In FIG. 25 a cable pulling device 215 is shown for pulling the set of single core extension power cables 65, 67, 69 of FIGS. 7 to 11 wound in multiple windings and in parallel upon the cable reel 51, of the cable reel and along a path between two electrical components and/or installations to be electrically connected. The pulling device 215 is configured to be attached to one end 217 of the set 77 of parallel wound extension power cables. In FIG. 25 the end 217 of the set 77 is shown. In particular a part of the length of the power cables 65, 67, 69 is shown that has arranged thereon three pre-installed cable binders 95 of the embodiment shown in FIGS. 13A and 13B. The number of three pre-installed cable binders 95 arranged on the part of the length of the power cables 65, 67, 69 that is shown in FIG. 25 is merely an example. The respective ends of the power cables 65, 67, 69 have been prepared for electrical connection by each being provided with a respective electrical connector 219, 221, 223.

The cable pulling device 215 is provided with a cable attachment 220 that is configured to be attached to the middle one 67 of the power cables by means of a cable stocking 219. Each of the ends of the outer ones of the power cables 65, 69 is engaged by a respective cable engagement e.g. embodied by a flexible tube 225, 227. The flexible tubes 225, 227 are arranged along the middle power cable 67 in parallel relationship on opposite sides of the middle power cable 67. The electrical connectors 219, 223 are slidable arranged in the flexible tubes 225, 227, such that the flexible tubes 225, 227 engage the ends of the power cables provided with the electrical connectors 219, 221 while allowing back and forth translation of the ends of the outer power cables 65, 69 relative to the middle power cable 67 along a part of the length of the middle power cable 67. The latter allows for compensating the difference in length of the paths of the respective power cables 65, 67, 69 along a curved path. The occurrence of such difference is explained herein above under reference to FIGS. 14 and 15.

The ends of the flexible tubes 225, 227 closest to the electrical connector 221 of the middle power cable 67 are held by a tube holder 229 that in turn is held by a yoke 231. The flexible tubes 225, 227, the pre-installed cable connector 95 closest to the flexible tubes 225, 227, and the yoke 231 are enclosed by a sleeve 233 of the cable pulling device 215. The yoke 231 guides the sleeve 233 along the electrical connector 221 and serves as a frame for the part of the sleeve that extends along the electrical connector 221. Pulling cables 220 extend from the cable stocking 219 along the electrical connector 221. A first pulling cable guide 235 is arranged on the electrical connector 221 and a second pulling cable guide 237 is arranged on the yoke 231. The first and second pulling cable guides 235, 237 guide the pulling cables 220 along the electrical connector 221 and through the yoke 231.

Additionally respective collar 239, 241 may be arranged on the electrical connectors 219, 223, that has a diameter of almost the diameter of the flexible tube to prevent tilting—and hence possibly slumping—of the respective electrical connector 219, 223 in the flexible tube 225, 227. Alternatively, instead of the collar, a respective coil spring may be arranged in the flexible tubes 225, 227 that extends between the pre-installed cable connector 95 closest to the flexible tubes 225, 227 and the electrical connectors 219, 223, wherein the outer power cables 65, 69 extend through the coil spring. Optionally, a second spring engagement member is configured to be fixed between the connector or termination at the end of the engaged power cable and the other side of the spring.

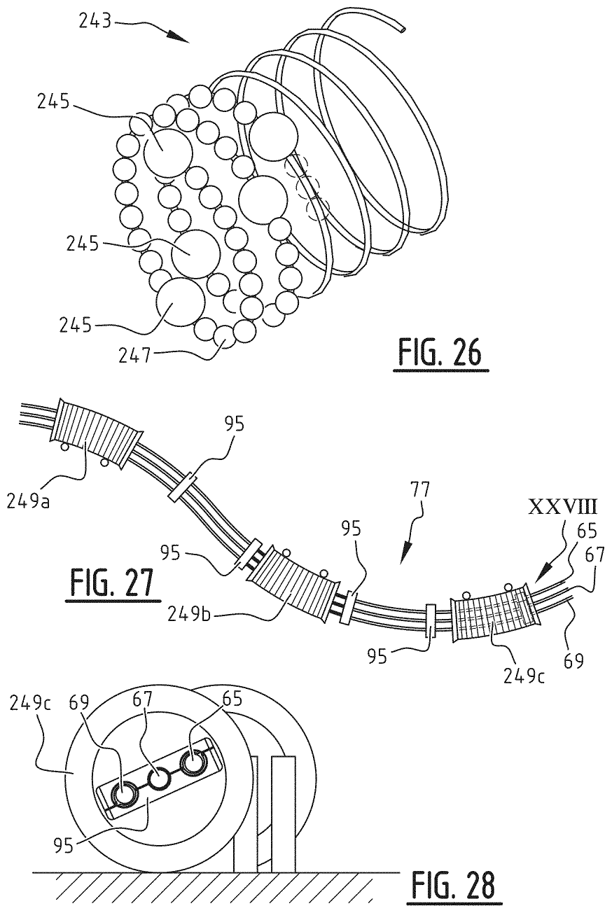

As shown in FIG. 26 such a coil spring 243 may advantageously have balls 245 arranged on the coils thereof with spacers arranged on the coils between the balls 245. In the embodiment shown in FIG. 26, the spacers are embodied by smaller balls 247. The bigger balls 245 fill the space between the outer surface of the outer power cables 65, 67 and the inner surface of the flexible tubes, thereby preventing tilting of the respective electrical connector 219, 223 in the flexible tube 225, 227. The smaller balls 247 define the location of the bigger balls 245 along the length of the coil. The locations of the bigger balls 245 are defined such that the bigger balls 245 of neighbouring coils do not come into contact when the coil spring 243 is compressed.

FIG. 27 shows in schematic top view the set 77 of single core power cables of the system according to the present invention as shown in FIGS. 7 to 11 that is pulled along a path and is guided along curves in the path by means of a series of bend guide tubes 249a, 249b, 249c. Each of the bend guide tubes 249a, 249b, 249c is provided with a funnel at both ends. Each of the bend guide tubes 249a, 249b, 249c, is anchored to the ground surface along which the set 77 of power cables is pulled. FIG. 28 shows a cross sectional view of the set 77 of single core power cables of FIG. 27 showing the orientation of the set 77 of single core power cables in one of the bend guide tubes 249c. As shown in FIG. 28 the set 77 of single core power cables can assume a tilted orientation in de bend guide tubes 249 relative to the ground surface, thereby reducing the difference in length of the paths of the respective power cables 65, 67, 69 along the respective curves.

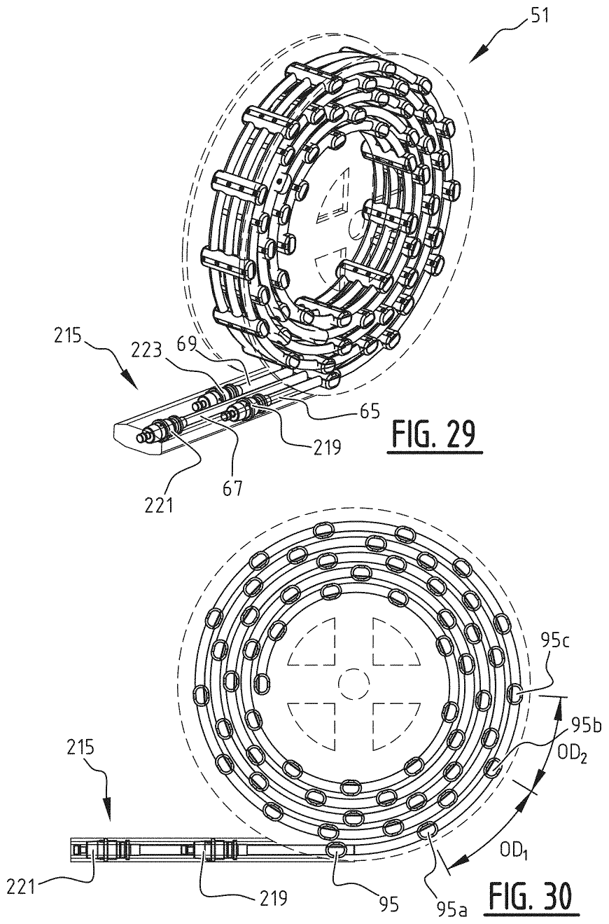

In FIGS. 29 and 30 a cable reel 51 is shown filled with three single core power cables 65, 67, 69 wound in parallel and in several windings upon the cable reel 51 as a set 77 of single core power cables. As shown the single core power cables 65, 67, 69 are, in accordance with FIG. 25, provided at an end thereof with connectors 219, 221, 223 that are accommodated in a cable pulling device 215. The power cables 65, 67, 69 are mutually joined along the length thereof by means of pre-installed cable binders 95. As shown the respective pre-installed cable binders 95a, 95b, 95c, are distributed along the shown length such that neighbouring preinstalled cable binders 95a/95b, 95b/95c are mutually offset in longitudinal direction of the power cables 65, 67, 69 over an offset distance OD1, OD2. The mutual offset in longitudinal direction of the power cables 65, 67, 69 between neighbouring cable binders 95 is such that preinstalled cable binders 95 of adjacent windings do not overlap, i.e. are not in contact. To achieve the latter, the offset distance between neighbouring cable binders 95 may differ along the length of the power cables. For instance in FIG. 30 is the offset distance OD1 is greater than the offset distance OD2.

In FIGS. 9 to 11 that show an embodiment of the method and system according to the present invention, a single set of three single core power cables is installed. In case the installation of multiple sets of single core power cables is required, there are several alternative ways of doing so.

A first way of installing multiple sets of single core power cables, for instance four sets of three single core power cables, is to deliver four cable reels 51 on site each arranged on a respective vehicle, and to separately arrange each set of single core power cables on the ground as described herein above under reference to FIGS. 9 to 11.

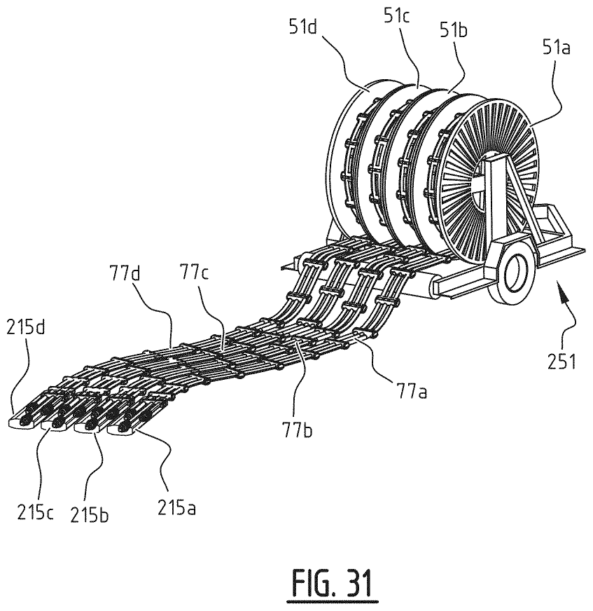

A second way of installing multiple sets of single core power cables is shown in FIG. 31. In FIG. 31 is shown that four sets 77a, 77b, 77c, 77d of three single core power cables, each wound on a respective one of four cable reels 51a, 51b, 51c, 51d is delivered on site. Each of the four cable reels 51a, 51b, 51c, 51d is arranged on a spindle of a single vehicle 251. The vehicle 251 is pulled along a path e.g. by means of a tractor (not shown) and while being moved along the path, the four cable reels 51a, 51b, 51c, 51d are unwound such that the four sets 77a, 77b, 77c, 77d of power cables are simultaneously arranged on the ground. Instead of simultaneously unwinding the cable reels 51a, 51b, 51c, 51d, it is also possible to simultaneously unwind two or three of the cable reels 51a, 51b, 51c, 51d, or even only one.

A third way of installing multiple sets of single core power cables, for instance three sets of three single core power cables, each wound in parallel and in several windings on a respective one of three cable reels as a set of single core power cables, is to make use of a single self-propelled vehicle, the sets of single core power cables can be arranged separately or preferably simultaneously on the ground by moving the self-propelled vehicle having arranged thereon the three cable reels along a path while simultaneously unwinding the respective sets of power cables as described herein above under reference to FIG. 31.

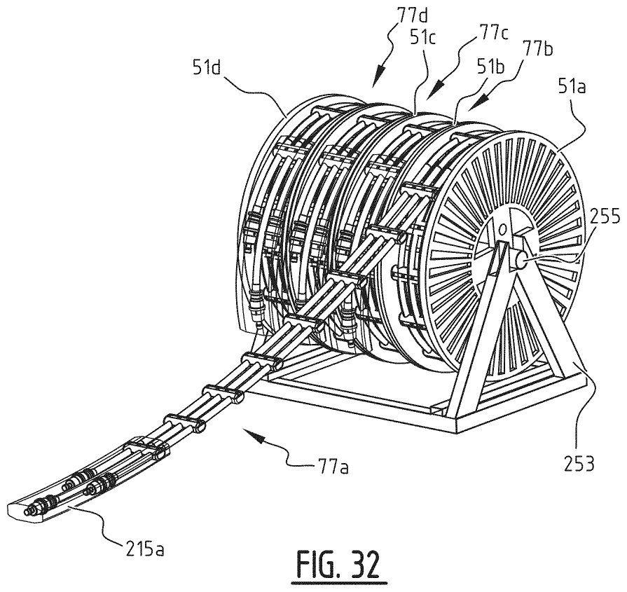

For arranging a single set of single core power cables on the ground as described under reference to FIGS. 9 to 11, and for arranging multiple sets of single core power cables on the ground according to each of the above described alternative ways of arranging multiple sets of single core power cables on the ground, the following it is noted. Instead of arranging the cable reel or cable reels on a vehicle and move this vehicle along a path while unwinding the set or sets of power cables, it is alternatively possible to arrange the cable reel or cable reels on a stationary frame and arrange the set or sets of single core power cables along the path by unwinding the cable reel or cable reels by pulling the set or sets of single core power cables along the path. As an example, in FIG. 32 a stationary frame 253 is shown with a spindle 255 having arranged thereon four cable reels 51a, 51b, 51c, 51d each being filled with a respective set 77a, 77b, 77c, 77d of single core power cables. As shown in FIG. 32 one of the four cable reels 51a, 51b, 51c, 51d is being unwound by pulling the set 77a of single core power cables that is wound on the cable reel 51a of the cable reel 51a and along the path. In particular the set 77a of power cables may be pulled via the cable pulling device 215a that can be arranged on an end of the set 77a of power cables in order to cope with the length differences that occur between the different cables of the set 77a of power cables whilst arranging the set along a non-linear path.

In the FIGS. 1 to 32 sets 77 of three single core power cables are shown. It is equally possible that a set of single core power cables has two or more than three single core power cables. The system according to the present invention comprises at least one cable reel filled with at least two single core power cables wound in parallel and in several windings upon the cable reel as a set of single core power cables.

FIGS. 9 to 15 relate to an embodiment of the system according to the present invention wherein the at least two single core power cables wound in parallel and in several windings upon the cable reel as a set of single core power cables are mutually joined along the length of the power cables by means of preinstalled cable binders. Alternatively, the at least two single core power cables wound in parallel and in several windings upon the cable reel as a set of single core power cables are mutually joined along part of the length of the power cables by means of preinstalled cable binders. In a further alternative embodiment the at least two single core power cables wound in parallel and in several windings upon the cable reel as a set of single core power cables are not mutually joined by means of preinstalled cable binders.

Although the principles of the invention have been set forth above with reference to specific embodiments, it must be understood that this description is given solely by way of example and not as limitation to the scope of protection, which is defined by the appended claims.

1-43. (canceled)

44. A cable binder for mutually joining in parallel a multitude of cables, comprising:
a cable binder body provided with a multitude of accommodations, wherein each accommodation is configured to receive one of said cables, and a locking member configured for locking the cables in said accommodations;
wherein the cable binder body comprises an elongated main body part;
wherein at least two divider walls extend from one side of said main body part, substantially perpendicular thereto, at a distance from the outer ends of said main body part;
wherein at least one of said cable accommodations is formed by an adjacent pair of said at least two divider walls and the part of the main body part extending between said pair of divider walls; and
wherein two of said cable accommodations are each formed by one of said at least two divider walls and the adjacent outer end of said main body part.

45. The cable binder in accordance with claim 44, wherein the main body part is provided with oblique or curved wall parts adjacent said divider walls, such that the cables are fixed in a predetermined position when the locking member is locking the cables in the accommodations.

46. The cable binder in accordance with claim 44, wherein the locking member is a strap which is wound around the main body part and the divider walls while a cable is present in each of the cable accommodations.

47. The cable binder in accordance with claim 44, wherein the top side of the main body part of the cable binder body is provided with strap guiding means for preventing lateral movement of the strap,

48. The cable binder in accordance with claim 47, wherein the strap guiding means are in the form of upright side ridges.

49. The cable binder in accordance with claim 44, wherein strap holders are provided inside said cable accommodations formed by each adjacent pair of said at least two divider walls and the part of the main body part extending between said pair of divider walls, which strap holders are arranged to hold said strap inside said cable accommodation on either side of the cable and thereby firmly engaging said cable and pulling the cable against the main body part.

50. The cable binder in accordance with claim 49, wherein said strap holders are bolts extending in parallel inside said cable accommodation, one on each side of the cable, wherein the strap is guided in a zig-zag manner inside the cable accommodation, first through the space between said strap holder and the main body part on one side of the cable, then around the cable and then through the space between said strap holder and the main body part on the other side of the cable.

51. The cable binder in accordance with claim 44, wherein the cable binder body comprises three accommodations for holding three cables.

52. The cable binder in accordance with claim 44, wherein the locking member is a strap.

53. The cable binder in accordance with claim 52, wherein the strap is closed and locked by means of a fast closing buckle.

54. The cable binder in accordance with claim 44, wherein screw-eyes are provided between the cable accommodations to hook up the cable binder.

55. The cable binder in accordance with claim 44, wherein the cable binder body is made of a plastic material.

56. The cable binder in accordance with claim 49, wherein, the strap holders are in the form of bars.

57. The cable binder in accordance with claim 56, wherein the strap holders are bolts.
